(19) United States
(12) Patent Application Publication
(10) Pub. No.: US 2023/0274361 A1
(43) Pub. Date: Aug. 31, 2023

(54) DISTRIBUTED LEDGER TECHNOLOGY FOR ASSET-BACKED SECURITIES

(71) Applicant: Cadwalader, Wickersham & Taft LLP, New York, NY (US)

(72) Inventors: Michael A. McCORMACK, New York, NY (US); Dylan GRAHAM, Brooklyn, NY (US); Robert KIM, New York, NY (US); Anna GLICK, New York, NY (US); Monica CONCEPCION, Jackson Heights, NY (US); Eyal GUY, Brooklyn, NY (US); Albert CHAN, Brooklyn, NY (US); Erez PARAG, North Woodmere, NY (US); Mike TYLER, New York, NY (US)

(21) Appl. No.: 18/019,355

(22) PCT Filed: Aug. 13, 2021
(86) PCT No.: PCT/US2021/045886

§ 371 Date: Feb. 2, 2023

Related U.S. Application Data
(60) Provisional application No. 63/065,469, filed on Aug. 13, 2020.

(51) Int. Cl. G06Q 40/06; G06F 16/23; G06F 16/27

(52) U.S. Cl. CPC G06Q 40/06; G06F 16/2379; G06F 16/27

(57) ABSTRACT

Improvements in distributed ledger technology for capturing, maintaining and updating data for asset-backed securitizations are described. The invention provides a distributed ledger platform which automates the capture of specified data regarding the underlying financial assets, including owners, trustees, servicers and other parties associated with asset-backed securitizations, and stores and maintains the data in a blockchain to provide users with a secure, reliable, immutable and distributed ledger of the data and to generate custom data reports of information stored in the ledger. An offchain database may be maintained in synchrony with the blockchain to allow for reduced computational load. The invention also provides a mechanism for managing changes in the data using a smart contract based consensus mechanism, for example, to record securitization party replacements in an automated manner.

### FIELD OF THE INVENTION

The present invention is directed to providing improvements in distributed ledger technology for asset-backed securitizations.

### BACKGROUND

Asset-Backed Securitizations

In the financial industry, asset-backed securities (ABS) are fixed-income or other securities collateralized or backed by a pool of any type of self-liquidating financial assets, such as loans, leases, mortgages, or secured or unsecured receivables, that allows the holders of the asset-backed securities to receive payments that depend primarily on cash flow of such underlying financial assets, in accordance with Section 3(a)(79) of the Securities Exchange Act of 1934, as amended (the “Exchange Act”).

An asset-backed securitization is the process by which asset-backed securities are issued, which involves (i) the pooling and sale of the underlying financial assets into a special purpose vehicle (which will continue to hold such financial assets so long as the asset-backed securities are outstanding), and (ii) the issuance and sale to investors, of the asset-backed securities (which may be referred to as bonds, pass-through certificates, or collateralized loan obligations (CLO)) which are backed by the pool of underlying financial assets. The holders of the asset-backed securities are entitled to receive interest, principal and other payments collected from the underlying financial assets. Asset-backed securitization permits originators of such underlying financial assets to sell such assets to raise capital, which may be used to originate additional financial assets, while also transferring certain of the risks of ownership of such financial assets to investors in the asset-backed securities. ABS is a mature, well-developed market: over $306 billion of ABS were issued in the United States in 2019 according to the Securities Industry and Financial Markets Association.

A typical asset-backed securitization is exemplified in FIG. 1. In FIG. 1, a lender has originated loans and wishes to sell the loans via an asset-backed securitization transaction. The loan seller sells the loans (1) to a depositor for cash (8). The depositor, typically an affiliate of the loan seller, is an entity created by the loan seller to facilitate securitizations. The depositor then creates a securitization trust to acquire the loans from the depositor (2) and issue securities. In this example, the securitization trust issues pass-through certificates (3) which are transferred to the depositor in exchange for the loans. The pass-through certificates evidence an ownership interest in the cashflow on the loans owned by the securitization trust. The depositor sells the pass-through certificates (4) to a broker/dealer who sells the pass-through certificates (5) to investors in exchange for cash (6). The cash (6) paid by the investors to the broker/dealer for the pass-through certificates is paid to the depositor (7) as consideration for the pass-through certificates, and by the depositor to the loan seller (8) as consideration for the initial purchase of the loans.

Once the asset-backed securitization transaction is consummated, the issued asset-backed securities (pass-through certificates in the example above) will continue to be outstanding for a specified duration, and during this period, the investors who purchased such asset-backed securities will continue to receive payments of interest, principal and other amounts collected on the underlying pool assets. During the life of the securitization, the transaction parties that have been engaged to administer the securitization, such as a trustee, a certificate administrator, a master servicer, a special servicer, and an operating advisor, will continue to perform their respective roles, such as maintaining custody of the pool assets, collecting payments on the pool assets, servicing the pool assets, calculating and making distributions to investors in the asset-backed securities, and generating periodic reports.

Split Loans

Asset-backed securitizations often involve the pooling of hundreds or even thousands of substantially fungible financial assets that, individually, might be illiquid, but once pooled together and securitized, are readily sold to investors in the form of asset-backed securities. However, with respect to at least one type of ABS, commonly referred to as commercial mortgaged-backed securities (CMBS), additional “financial engineering” is required. Because in the case of CMBS, the type of underlying financial assets is loans secured by commercial real properties, the size of a single underlying financial asset can be very large and may, for example, take the form of a commercial mortgage loan with a principal balance of over $1 billion. The inclusion of such a large financial asset in a single securitization pool is not feasible, as it would violate pool diversification requirements dictated by the investors in the CMBS market and by the rating agencies that provide credit ratings for the issued CMBS.

In such instances, instead of including the entire commercial mortgage loan in a single securitization, the originator of the asset or the “loan seller” may split the loan into multiple portions and sell portions of the loan into multiple, separate securitizations. For example, a bank originating a loan with an unpaid principal balance of $500 million secured by commercial real property, such as an office building, may “split” the loan into 5 separate portions, each representing 20% of the loan (with an unpaid principal balance of $100 million), and sell each portion into 5 separate securitizations. It is not uncommon for a single whole loan to be split into 5 or more related split loans. The entirety of a loan that has been split into multiple portions are referred to herein as “whole loans” and such portions of a whole loan are referred to herein as “split loans”, evidenced by “split notes”.

For the reasons described above, a pool of underlying assets that back CMBS often include multiple split loans that are portions of larger whole loans, as well as smaller loans that have not been split. It is not uncommon for a single CMBS transaction to include 10 or more split loans. The presence of multiple split loans in a securitization pool brings additional complexities and challenges to asset-backed securitizations with respect to information transparency and servicing and administering of the securitization pool, for the reasons described below.

Typically, in an asset-backed securitization, a transaction party designated as the “servicer”, “master servicer” and/or “special servicer” is given the role of servicing and administering the pool of securitization assets, and only those assets, that are included in the particular securitization to which is a party. However, in the case of split loans that have been included in multiple separate securitizations, it is not practicable for multiple servicers associated with those separate securitizations to simultaneously service essentially the same loan, notwithstanding the fact that each of those securitizations hold a related split loan. Consequently, in the case of split loans, prior to the securitization of any of the split loans, only one of the split notes (evidencing a split loan) is designated as the “lead servicing note,” and the servicing transaction party in the securitization that holds the “lead servicing note” is charged with the responsibility of servicing the entire whole loan for the benefit of all of the holders of a related split loan. Acting as the designated servicer of a whole loan involves functioning as the single point of contact with the borrower under the loan, collecting payments on the loan, making servicing decisions, and maintaining records relating to the loan.

This arrangement of providing for one securitization servicer that will service all of the related split loans as a group, on behalf of all of the related securitizations, means that each of the securitizations that hold a split note that is not the “lead servicing note” is dependent on the “lead servicer” in the securitization that holds the “lead servicing note” for receipt of payments on its split loan and information regarding its split loan, as well as general servicing of the loan. This arrangement for “lead servicing” of whole loans by a single servicer creates interdependencies across separate securitizations, each having different parties, that would not otherwise have a connection to one another.

FIG. 2 is a graphic presentation of how whole loans that have been split into multiple split loans may “straddle” multiple securitizations. FIG. 2 illustrates the complexity that is created by the practice of including multiple split loans in asset-backed securitizations. In the figure, each split loan is shown using a unique color. For each split loan, the lead servicing note is denoted which includes the name of the split loan. The non-lead servicing pieces of each split loan are represented by boxes of the corresponding color, but without the split loan name.

Access to Accurate and Timely Information on Split Loans

In CMBS securitizations, because of the interdependencies created among otherwise separate securitizations by the presence of split loans in their asset pools as described above, it is critical for each securitization to have, with respect to each split loan such securitization holds, accurate and timely information regarding the other related split loans that are held by other parties or securitizations, including the identity of the holders of all other related split loans (whether it be another securitization or another entity) and, in particular, the identity of the securitization holding the “lead servicing note” and its securitization servicer that will act as “lead servicer” for the particular split loan. Such information on split loans is critical for providing transparency to transaction parties to a securitization who may need to monitor and act based upon such information, and to investors in a securitization who may need such information to properly monitor their investment.

Such information regarding split loans that span across all related securitizations, however, is not readily available, because securitization transaction parties that are engaged with respect to a particular securitization are only responsible for, and are only familiar with, information regarding their own securitization and their own pool assets, and do not have easy access to information outside of their securitization. Moreover, there is no other party in the CMBS industry that is responsible for maintaining overarching split loan information across CMBS securitizations. The present practice is for transaction parties in each securitization to separately maintain their own records of the split loan information based on ad hoc processes, with no assurance that their information is accurate and up-to-date and matches the same information maintained by transaction parties in another securitization.

The difficulty in gaining access to, and maintaining, up-to-date information regarding all of the split loans comprising a whole loan is further compounded by the fact that originators of split loans typically include each split loan in a securitization in succession and at times of their choosing. Consequently, it is difficult for the transaction parties in prior securitizations that hold a split loan to obtain and maintain up-to-date information as to when and where the other related split loans have been subsequently securitized. To complicate matters even further, at the time of any of these successive securitizations, a split loan may be further subdivided into smaller split loans, at the discretion of the originator, to meet specific securitization requirements at the time of securitization. Another issue that poses additional challenges is that, from time to time, the split note designated as the “lead servicing note” is not the first split note in the group to be securitized, which necessitates the first securitization to hold one of the related split notes to provide “lead servicing” on a temporary basis until such time the “lead servicing note” is securitized, at which point “lead servicing” will “shift” to the securitization that holds the “lead servicing note.” These changes in the status of split loans and lead servicing need to be disseminated to all impacted parties. The present practice is to rely on notifications that are required to be sent to relevant parties at the time of each securitization; there is no assurance, however, that these notices are infallibly sent and received.

There is currently no platform or system at the industry-wide level for identifying all of the splits loans constituting a whole loan included in CMBS securitizations and uploading and maintaining relevant information with respect to all of the split loans, including information regarding the securitizations and other parties that are holders of each of the split loans. Securitization parties expend significant time and resources maintaining records tracking ownership and servicing of split loans.

There is therefore an unmet need for a system that maintains and manages records of ownership of split loans and other related information in real time, and in a manner that ensures the timeliness and accuracy of those records. A system to collect, maintain and update such information would clearly benefit all parties involved in asset-backed securitizations.

Replacement of Servicing Party for Split Loans

As described above, in CMBS securitizations, all of the split loans comprising a whole loan are serviced, on behalf of holders of all of the related split loans, by the securitization servicer (or servicers) associated with the securitization that holds the split note that is designated as the “lead servicing note.” The “lead securitization servicer (or servicers)” will continue to service the whole loan unless and until it is terminated or replaced or it resigns, in accordance with the terms of the transaction agreements relating to the CM BS securitization in which the “lead servicing note” is included. In CMBS securitizations, it is customary for certain class of investors in the securitization to have the right to remove and replace servicers associated with the securitization, and consequently, a replacement of the securitization servicer may also occur as a result of the exercise by these investors of such rights. If the securitization servicer(s) for a securitization is removed and replaced (whether as a result of termination by the securitization trustee for cause, resignation, or removal and replacement initiated by investors who have that right), it means that, with respect to split loans in the securitization pool for which the removed securitization servicer was acting as “lead securitization servicer”, the other securitizations that own the related non-lead split notes that depend on the “lead servicing” by such removed servicer are impacted and will need to be informed.

CMBS transactions are often public offerings registered with the United States Securities and Exchange Commission (“SEC”). The registrant for such deals is typically the depositor, and the registered securities are offered pursuant to a registration statement on SEC Form SF-3 (“Registration Statement under the Securities Act of 1933”). One of the eligibility requirements, in accordance with 17 CFR 239.45, for the use of Form SF-3 is that the registrant must timely file a Form 8-K with respect to certain events, including events required to be reported under Item 6.02 (Change of Servicer or Trustee), which includes among other events, both events constituting “servicing shifts” and removal and replacement of a servicer described above. These Form 8-Ks are required to be filed within four (4) days of the reportable event and must contain a timeliness certification. References herein to specific SEC Forms, such as Form SF-3, Form 10-D, Form 10-K and Form 8-K are deemed to include references to any amendments to such forms, such as Form 8-K/A etc. The methods described herein take into account such amended versions of the original forms, and would also apply with respect to documents filed, collected or stored in any document repository other than EDGAR.

Thus, in the case described above where the “lead servicing note” is not the first split note to be securitized and “lead servicing” was assumed on a temporary basis by the first securitization until such time the “lead servicing note” was securitized, when the “servicing shift” occurs to the subsequent lead servicing securitization upon inclusion of the “lead servicing note” into a securitization, the depositors of each related split loan are suddenly under a 4-day filing due date to complete and file a Form 8-K reporting the change of servicer, or potentially lose their eligibility to issue registered securities. Likewise, if the investors in the CMBS transaction that holds the “lead servicing note” elect to replace the servicer with their preferred servicer or the servicer is otherwise terminated or resigns, a servicing transfer will occur, which is a reportable event for each depositor of a securitization holding a related split loan. The Form 8-K reports are intended to ensure that investors in each CMBS transaction that owns a split loan serviced by another CMBS transaction have information regarding the servicers of the whole loan.

The CMBS transaction documents include detailed contractual provisions intended to ensure that the depositors obtain from the depositors of each other CM BS transaction, notice of reportable events caused by servicing shifts and servicing transfers. These contractual provisions have, in practice, proven to be difficult to implement, and contractual remedies are typically inadequate to protect depositors from the potentially significant financial losses that might result if they were to become ineligible to undertake registered offerings of CMBS. Although it may appear straightforward to provide and receive notice of servicing shifts and servicing transfers, given the multiplicity of parties and split loans, the complexity of the transactions, and the speed and accuracy with which the necessary information must be conveyed, in practice, traditional methods of notice have proven inadequate.

For example, the contractual provisions that typically govern the replacement of one of the servicing parties to a CM BS transaction, referred to as the special servicer, can be considered. Investors, typically the directing certificate holder, have the right to remove the special servicer and appoint their preferred replacement special servicer. This servicing transfer is governed by the contractual terms of the CMBS transaction that includes the “lead servicing note.”

Under the terms of that agreement, which is typically a pooling and servicing agreement or a trust and servicing agreement, the directing certificate holders would give notice to the trustee of the CMBS transaction that owns the “lead servicing note.” That trustee would then provide notice of the proposed servicing transfer to the owners of the related split loans, which would be, with respect to any split loans included in CMBS transactions, the trustees and certificate administrators of those other CM BS transactions. The directing certificate holder is required to cause the successor special servicer to deliver to the trustee of the lead servicing note CMBS transaction certain documents, such as an opinion of counsel, confirmation from any rating agencies rating the securities issued by the lead servicing note CMBS transaction, and each other CM BS transaction owning a related split loan, an assumption agreement and a notice of reportable event, attaching information about the successor special servicer that may be required to be included in any Form 8-K filing required to be made. The trustee of the CM BS transaction that owns the lead servicing note must therefore track and record who owns each split loan (if a split loan has been securitized, the trustee and certificate administrator of the related CMBS transaction). Furthermore, these parties may change, as the split loans may be sold or securitized, or the parties to a securitization transaction may be changed due to resignations, removals or terminations. In addition, split loans may themselves be further split into additional split loans.

Maintaining up-to-date records of the various split loans, the related CMBS transactions, and the parties to those CM BS transactions is difficult and time consuming and inaccurate or incomplete information may preclude prompt preparation and submission of required Form 8-K filings, resulting in a loss of registration statement eligibility. Further, there is currently no ability to timely collect and process the information related to asset-backed transactions from the various sources.

In the United States, registrants of publicly offered CM BS are required by the Securities Act to file an Annual Report on Form 10-K each year for each of its issuing entities offering CMBS. Each issuing entity's Form 10-K requires the related registrant to indicate that they have filed all reports required by Section 13 or 15(d) of the Securities Exchange Act during the preceding 12 months (or for such shorter period that the registrant was required to file such reports). Examples of such reports include Form 10-D (“Asset-Backed Issuer Distribution Report”) and Form 8-K (“Current Report”). In order to make this indication, registrants must review all of the Exchange Act filings (i.e., Forms 10-D and 8-K) made by each of its issuing entities during the relevant reporting period. Each issuing entity (excluding any formed during the relevant reporting period, as they are only required to report for the portion of the reporting period during which they existed) will have a minimum of 12 filings, plus any Form 8-K filings required to be made during the applicable reporting period. Many registrants have formed 60 or more issuing entities, meaning they must review a minimum of 720 filings each reporting period in order to indicate they have made all the required filings. It would be desirable to expedite review of the relevant flings to facilitate preparation of the necessary filing reports.

At times, there are situations where a party to a transaction may be removed under the terms of a subject agreement, and the other depositors do not vote to approve such a change. Examples of such situations are: 1) a transaction party has the right to terminate a servicer without cause, 2) a transaction party defaults, 3) a transaction party resigns or is legally prohibited from performing (e.g., due to loss of license), or 4) there is a merger or consolidation of such party. Because these events may be required by the SEC to be reported, the depositors may be required to file a transaction reporting document with a repository (for example, a Form 8-K with EDGAR) even if they have not voted for the change. It would be desirable to have a system which in such circumstances would send depositors a notification informing them that a change has occurred, and that the depositors will need to assess if they have to report this change to the repository.

Although there are distinct advantages to recording data in a blockchain, blockchain applications are computationally intense and it can be desirable to reduce the amount of computation involved with blockchain applications and transactions.

There is currently no platform or system at the industry-wide level (1) for maintaining accurate and timely information with respect to all of the split loans, including information regarding the securitizations and other parties that are holders of each of the split loans, (2) for automating and controlling the servicer replacement process across multiple securitizations so that the depositors of each impacted securitization are identified and are given adequate time and information to prepare and timely submit their required Form 8-K filings; and (3) for reducing computational intensity when reading or processing data in a blockchain. There is therefore an unmet need for such platform or system.

### SUMMARY OF THE INVENTION

The present invention addresses the problems discussed above and provides a novel system and method which facilitate the creation, maintenance, and updates to records of ownership and other information regarding underlying financial assets, such as (but not limited to) split loans, included in asset-backed securitizations, and information regarding the parties involved in such asset-backed securitizations, while reducing processor activity as compared to prior blockchain applications, as described with reference to the present invention.

It has been surprisingly discovered that distributed ledger technology provides an ideal practical solution that permits securitization parties to access common sources of information regarding the ownership and servicing of split loans that span across multiple securitizations and to facilitate compliance with SEC requirements by such parties.

The example embodiments discussed herein provide numerous benefits over a traditional database hosted on a generic computing platform. For example, through the blockchain, the inventive embodiments provide for immutable accountability, security, privacy, permitted decentralization, availability of smart contracts, endorsements, enhanced trust, and accessibility that are inherent and unique to the blockchain. In one embodiment, the present invention improves functioning of computers by reducing the computational load that is borne by a computer (or system of computers) conducting blockchain transactions by maintaining an offchain database in synchrony with the blockchain. The offchain database can be quickly searched using standard queries, for example, SQL, with minimum expenditure and does not require computationally intensive decryption, as compared to typical searches of a blockchain which need to decrypt (or encrypt) the data stored in the blockchain when conducting queries.

A traditional database could not be used to implement the example embodiments because it does not provide for trusted collaboration or tamper proof storage and preservation of the underlying data. If a traditional database were to be used to implement the example embodiments, the embodiments would suffer from unnecessary drawbacks such as lack of data security, especially when multiple parties need to share information in a distributed manner and are reluctant to do so because of competing business interests or other reasons.

The term “financial asset” as used herein is intended to describe any type of financial asset underlying an asset-backed security to which the present invention can apply. The term “transaction reporting document” is intended to describe any kind of document submitted to a governmental, industry, or private repository for the purpose of reporting an asset-backed securitization transaction which may comprise a commercial real estate loan as kind of financial asset or to comply with any reporting requirements with respect thereto, including, but not limited to, a registration statement, prospectus or Form 8-K filing, which may include, as exhibit thereto, a pooling and servicing agreement, or a trust and servicing agreement. A “transaction reporting document” may also be a pre-existing or legacy document located in a repository and containing transaction information but which has not been specifically prepared for use by the invention. The term “blockchain exhibit” as used herein is intended to describe any kind of document or document component (such as a data table or data list) which contains information structured or formatted to be readable for use by a data crawler of the invention, as further discussed below.

The invention is broadly applicable for use in any kind of transaction such as an asset-backed securitization transaction. Depending on the particular implementation of the invention, transaction reporting documents that may include blockchain exhibits may be filed or deposited with a governmental repository such as EDGAR or maintained in a private repository such as (but not limited to) an industry-sponsored system or a company-owned document management system. In alternative embodiments, documents which do not contain a custom-formatted blockchain exhibit may be “read” using artificial intelligence (“AI”), machine learning, or other automated systems which can extract information from the documents for use by the invention. For example, the novel crawler (further discussed below) may search auto loan documentation or other materials stored in a repository such as a corporate data room, a document management system such as iManage, DocuWare, and ShareFile, or a network folder or directory containing relevant or collected documents. Such legacy transaction reporting documents may not have a custom-formatted blockchain exhibit but yet are readable by the crawler of invention. In the discussion below, the invention will be exemplified with particular reference to commercial real estate loans as a kind of financial asset included in commercial mortgage-backed securitization (CMBS) transactions as one particular type of asset-backed securitization transaction, and reference will periodically be made to documents and document exhibits stored in the EDGAR repository (Electronic Data Gathering, Analysis, and Retrieval system maintained by the SEC) as exemplars of transaction reporting documents. Such discussions are only an exemplary embodiment of the present invention and it is to be understood that the invention is not limited to CMBS transactions or involve documents stored in the EDGAR repository.

A person of skill in the art will understand that the principles of the invention are broadly applicable to any kind of asset-backed securitization including but not limited to securitizations involving corporate loans, auto loans, credit card receivables, student loans, leases, commercial mortgages, home mortgages, home equity loans, royalties, syndicated loans, secured personal loans, unsecured personal loans, and billing receivables. The principles of the invention can also be applied to any kind of repository that stores transaction reporting documents, as further discussed below. In certain embodiments of the invention, the transaction reporting documents themselves can be parsed for the specified data, or the data may be included in a custom blockchain exhibit which is then parsed and data extracted for inclusion in the blockchain. A person of skill will also understand that the repository is not limited to U.S.-based repositories, and that the invention can be practiced anywhere in the world. Similarly, the repository may be industry-sponsored and/or located on a private server such as a document management system or network or local folder or directory, and the invention may access documents “filed” or saved on such a private server or repository.

For example, although asset-backed securitizations of auto loans have a different constitution and structure as compared to CMBS transactions, the principles of the present invention are nevertheless also applicable to asset-backed securitizations of auto loans, as CMBS and auto loan securitizations have similar problems to solve with regard to maintaining and managing records of ownership and changes to securitization parties. The principles of the invention may also be applied to other asset-backed securities and other securities and financial instruments, including, but not limited to syndicated loans or other kinds of debt or equity offerings. Persons of skill will be able to apply such principles of the invention to various kinds of asset-backed securitizations.

In the case of certain types of asset-backed securitizations (for example, those that are private offerings and not registered with the SEC), submission of transaction reporting documents to a governmental repository may not be required. In such instances, an industry organization, trade group, or a group of interested companies or financial institutions may establish its own repository and promulgate guidelines for deposit or filing of relevant transaction reporting documents with the repository. The novel data crawler (further discussed below) can then monitor the repository and add the relevant asset-backed securitization data to the blockchain in such embodiments in accordance with the principles of the present invention. In alternative exemplary embodiments, the repository may be a document management system or a networked or non-networked folder or directory on a server or storage disk which contains relevant transaction reporting documents, and the novel crawler searches these documents for information for input into the system of the invention.

A first aspect of the present invention is directed to a computer-based method. The method may comprise the steps of: identifying, from a set of transaction reporting documents for an asset-backed securitization based on a pool of underlying financial assets, a collection of transaction reporting documents; parsing each identified transaction reporting document of the collection to extract data which is to be added to a blockchain and generating a crawler object from the extracted data, each crawler object representing data parsed from the collection, and a plurality of crawler objects forming a crawler object library; parsing the crawler object library and generating a data object library, each unique data object representing a single transaction to be added to the blockchain and having an associated instruction to add each unique transaction to the blockchain; executing the instructions in the data object library to add each unique transaction and the data associated thereto to the blockchain; and generating a report showing the updates to the blockchain. In certain embodiments, the crawler may parse a custom blockchain exhibit instead of the text of the transaction reporting document to extract data for addition to the blockchain.

Another aspect of the present invention is directed to a computer-based method which may comprise the steps of: searching, via a node of a distributed ledger platform, a set of transaction reporting documents for an asset-based securitization backed by a pool of underlying financial assets for a transaction reporting document comprising associated financial asset data; extracting from the transaction reporting document, via the node, the financial asset data therein; building, via the node, an instruction to compare the extracted financial asset data to a blockchain database comprising data for a plurality of financial assets; assessing, via the node, based on the comparison whether the financial asset is a securitized asset or a non-securitized asset; communicating the assessed securitization status of the financial asset to the blockchain; writing, via the node, the securitization status of the financial asset to the blockchain; and reconciling, via the node, the securitization status of the financial asset in the blockchain with the securitization status of the financial asset in an offchain database. In certain embodiments, the crawler may parse a custom blockchain exhibit instead of the text of the transaction reporting document to extract data for addition to the blockchain. Interacting with the offchain database is less computationally intensive than interacting with the blockchain and therefore requires less processor power.

Another aspect of the present invention is directed to a system for maintaining data using distributed ledger technology. The inventive system may comprise a first entity node comprising a processor, a communication interface, and a memory having a blockchain application stored therein, wherein the blockchain application comprises a blockchain comprising a plurality of data records.

The blockchain application, when executed by the processor, causes the processor to: crawl a set of transaction reporting documents to identify one or more transaction reporting documents; parse each transaction reporting document and generate a pending data object for each transaction reporting document to be added to the blockchain; generate a pending transaction object representing a transaction to be added to the blockchain and an associated instruction to add the transaction to the blockchain; convert each pending data object and pending transaction object to a permanent data record by appending the pending data record to the blockchain; and generate a report showing the updates to the blockchain. In certain embodiments, the crawler may parse a custom blockchain exhibit instead of the text of the transaction reporting document to extract data for addition to the blockchain.

Another aspect of the present invention is directed to a financial asset data management system using distributed ledger technology. The data management system may comprise a plurality of nodes, wherein at least one of the plurality of nodes is a computing system configured to broadcast financial asset data to the plurality of nodes. Each of the plurality of nodes may comprise a processor, a memory unit, and a bus, and each of the plurality of nodes may be connected to each other over a communication network, and each of the plurality of nodes may have access to a copy of a distributed ledger.

The processor of each of the plurality of nodes may be configured to: utilize blockchain protocols to verify and record a transaction occurring within the distributed ledger, wherein data is recorded as a block, wherein a blockchain is formed by the addition of blocks, wherein each block is encrypted by a mathematical formula that produces a hash value, wherein each block is linked to a previous block by the hash value of the previous block, wherein a consensus must be reached to update the distributed ledger with the addition of a new block; crawl a set of transaction reporting documents to identify one or more transaction reporting documents; parse each transaction reporting document and generate a pending data object for each transaction reporting document to be added to the blockchain; generate a pending transaction object representing a transaction to be added to the blockchain and an associated instruction to add the transaction to the blockchain; convert each pending data object and pending transaction object to a permanent data record by appending the pending data record to the blockchain, or to send each pending data object and transaction object to a distributed ledger node for storage in a blockchain record, and generate a report showing the updates to the blockchain.

Another aspect of the present invention is directed to a computer-based method which may comprise the following steps which may be performed in any logical order:
a. accessing, by a processor, a financial assets management database shared by all computing nodes participating in a distributed computing system based on a blockchain protocol, the financial assets database including transaction data and securities data, where the transaction data comprise transaction records, such as transaction objects, for securities and the securities data comprise administrative records, such as data objects, for securities, the blockchain comprising record blocks that confirm when and in what sequence certain transaction data became written to the blockchain;
b. receiving a request signed by a user system to include new data in the blockchain, wherein the new data has been previously parsed from a transaction reporting document in a document repository, and the additional data comprises new transaction objects and/or new data objects representing a change in transaction data and/or securities data of a financial asset and an instruction to add the new data to the blockchain; and
c. executing the instruction to thereby add a block that records the new transaction with additional data in the blockchain including a hash of a previous block and the block which is being added; and generating a report showing the updates to the blockchain. In certain embodiments, the crawler may parse a custom blockchain exhibit instead of the text of the transaction reporting document to extract data for addition to the blockchain.

Another aspect of the present invention is directed to a computer-based method which may comprise the steps of: identifying, from a set of transaction reporting documents for an asset-based securitization, a collection of transaction reporting documents; parsing each identified transaction reporting document of the collection to extract data which is to be added to a blockchain and generating a crawler object from the extracted data, each crawler object representing data parsed from a single transaction reporting document from the collection, and a plurality of crawler objects forming a crawler object library; parsing the crawler object library and generating a data object library, each data object representing a single transaction to be added to the blockchain and having an associated instruction to add the transaction to the blockchain; executing the instructions in the data object library to add each transaction and the data associated thereto to the blockchain; and generating a report showing the updates to the blockchain. In certain embodiments, the crawler may parse a custom blockchain exhibit instead of the text of the transaction reporting document to extract data for addition to the blockchain.

Another aspect of the present invention is directed to a method comprising the steps of: identifying transaction reporting documents in a repository filed by an issuing entity within a pre-defined reporting period, and saving data comprising document type and filing date in a blockchain of a distributed ledger; determining a filing due date within the reporting period for each of the transaction reporting documents in the blockchain; comparing respective filing due date and filing date for each of the transaction reporting documents within the reporting period; and generating a report showing the comparison.

In one embodiment, the set of transaction reporting documents may be a public or private repository maintained by a regulatory agency, an industry group, or another entity such as a private entity or a public entity.

In an embodiment of the invention, the step of identifying the transaction reporting document may comprise crawling an index file of the set of transaction reporting documents to identify transaction reporting documents satisfying one or more criteria. Exemplary criteria may be document type and standard industry classification (SIC) code. In an exemplary embodiment of the invention, the transaction reporting document may comprise a prospectus, a pooling and servicing agreement, a trust and servicing agreement, or a principal transaction document. In exemplary embodiment, the industry classification may be asset-backed securities and the report type is a Form 424B filing or a Form 8-K filing.

In any of the embodiments of the invention, identifying the collection of transaction reporting documents for crawling may comprise crawling an index file on a regular basis. The step of crawling the index file may be performed daily or over another time interval. The collection of transaction reporting documents may also be manually or automatically saved to the repository so that the data crawler reviews only documents which are known to be relevant or contain information for use by the invention.

In an exemplary embodiment of the invention, the set of transaction reporting documents to be crawled is the EDGAR repository.

In another exemplary embodiment of the invention, the set of transaction reporting documents to be crawled is a private repository containing transaction documents relating to the issuances of collateralized debt obligations.

In an embodiment of the invention, the transaction reporting document may comprise a custom novel blockchain exhibit. The novel blockchain exhibit may comprise any information deemed relevant to the financial assets underlying the asset-backed securities or asset-backed securities themselves, and the blockchain exhibit may be found or targeted using AI or other technology. In an exemplary embodiment, the custom blockchain exhibit may be an HTML file, text file, or other format file included with, embedded within, or attached to an existing transaction reporting document. In an embodiment of the invention, the blockchain exhibit comprises one or more data fields selected from the group consisting of unique securitization identifier, CIK code, file name, securitization name, securitization number, loan name, loan number, owner, depositor, trustee, servicer, securitization status, and lead servicing note.

A report may be generated after the report identifies the current parties associated with the financial asset.

The inventive method may be carried out on a distributed ledger platform and may comprise the step of replicating the blockchain in each node of the distributed ledger platform.

The invention may also comprise the step of maintaining an offchain database in synchrony with the blockchain. The step of maintaining the blockchain and the offchain database in synchrony may comprise the steps of: identifying one or more transaction records of the financial asset in the offchain database; identifying one or more transaction records of the financial asset in the blockchain; comparing the identified transaction records of the offchain database and the blockchain; identifying transaction records to be superseded in either the offchain database, the blockchain, or both; and writing to the blockchain and/or the offchain database a superseding transaction record reconciling discrepant financial asset data.

Another aspect of the present invention is directed to a computer-based method which may comprise the steps of: permitting an administrator of an asset-backed securitization selecting the asset-backed securitization transaction as to which a transaction service provider is to be replaced; preparing an electronic proposal to replace the current service provider with a replacement service provider, the proposal having a specified termination date, wherein the proposal automatically retrieves the identity of all required approvers across all impacted securitizations associated with the affected financial assets from an offchain database for the proposal; soliciting a response to the proposal from all applicable approvers; and entering the change of service provider to the replacement service provider as a transaction in a blockchain file upon failure to receive an objection from the approvers by the termination date. The current service provider to be replaced may be servicing financial assets, portions of which may be included in other asset-backed securitizations and therefore the replacement of the current service provider may have an impact on other securitizations or related securitizations. A transaction service provider is any party that has an administrative function for a financial asset such as an administrator, trustee, certificate administrator, servicer, or special servicer.

In an embodiment of the invention, the administrator is a trustee for the select asset-backed securitization, and the approvers are the owners of the split loans and/or the depositors of the asset-backed securitization transactions owning the various split loans.

The administrator may be any person or organization that has an administrative function associated with the asset-backed securitization, for example, a trustee, certificate administrator, servicer, or special servicer. In an embodiment of the invention, the approver may be one of a plurality of approvers.

In an embodiment of the invention, the transaction service provider is a master servicer or special servicer, and may be one of a plurality of servicers (or other administrators) to be substituted by a corresponding replacement servicer or administrator.

In an embodiment of the invention, the financial asset which is being added to the blockchain via the crawler is a split commercial mortgage loan serving as an underlying asset for commercial mortgage-backed securities, and may be a loan, a syndicated note, a lease, a mortgage, a secured receivable, or an unsecured receivable. A pool of underlying financial assets of an asset-backed securitization may include one or more assets such as (but not limited to) corporate loans, auto loans, credit card receivables, student loans, leases, commercial mortgages, home mortgages, home equity loans, royalties, syndicated loans, secured personal loans, unsecured personal loans, and billing receivables.

The proposal for which a response is solicited from the approver (or plurality of approvers) may be in the form of a smart contract.

Another aspect of the present invention is directed to a computing apparatus comprising at least one processor, and a memory storing executable instructions that, when executed by the at least one processor, causes the processor to perform any of the steps, methods, or operations described above.

Another aspect of the present invention is directed to a computer-implemented system. The system may comprise one or more computers and one or more computer memory devices interoperably coupled with the one or more computers. The system comprises tangible, non-transitory, machine-readable media storing one or more instructions that, when executed by the one or more computers, perform one or more operations such as any of the above-recited methods, operations, or steps.

Another aspect of the present invention is directed to a computer-based system. The system may comprise a processor and a computer-readable storage medium having instructions stored which, when executed by the processor, cause the processor to perform operations comprising any of the above-described methods, steps, or operations.

Another aspect of the present invention is directed to a non-transitory computer-readable storage medium having instructions stored which, when executed by a computing device, cause the computing device to perform any of the above-described operations, steps, or methods.

Another aspect of the present invention is directed to a novel node of a blockchain system. The node may comprise a processor configured to perform any of the above-described steps, operations, or methods.

Another aspect of the present invention is directed to a system for maintaining data using distributed ledger technology. The system may comprise a first entity node comprising a processor, a communication interface, and a memory having a blockchain application stored therein.

The blockchain application may comprise a blockchain comprising a plurality of data records, and the blockchain application, when executed by the processor, may cause the processor to: crawl a set of transaction reporting documents to identify information for inclusion in the blockchain, the transaction reporting documents optionally comprising one or more custom blockchain exhibits; parse each transaction reporting document or custom blockchain exhibit and generate a pending data object for each blockchain exhibit to be added to the blockchain; generate a pending transaction object representing a securities transaction to be added to the blockchain and an associated instruction to add the transaction to the blockchain; convert each pending data object and pending transaction object to a permanent data record by appending the pending data record to the blockchain, or send each pending data object and transaction object to a distributed ledger node for storage in a blockchain record; and generate a report showing the updates to the blockchain.

Another aspect of the present invention is directed to a securities data management system using distributed ledger technology. The inventive system may comprise a plurality of nodes, wherein at least one of the plurality of nodes is a computing system configured to broadcast securities data to the plurality of nodes. Each of the plurality of nodes may comprise a processor, a memory unit, and a bus, and each of the plurality of nodes may be connected to each other over a communication network, and each of the plurality of nodes may have access to a copy of a distributed ledger.

The processor of each of the plurality of nodes may be configured to: utilize blockchain protocols to verify and record a transaction occurring within the distributed ledger, wherein data is recorded as a block, wherein a blockchain is formed by the addition of blocks, wherein each block is encrypted by a mathematical formula that produces a hash value, wherein each block is linked to a previous block by the hash value of the previous block, wherein a consensus must be reached to update the distributed ledger with the addition of a new block; crawl a set of transaction reporting documents to identify information for inclusion in the blockchain, optionally in the form of one or more custom blockchain exhibits; parse each transaction reporting document or custom blockchain exhibit and generate a pending data object for each blockchain exhibit or other information to be added to the blockchain; generate a pending transaction object representing a securities transaction to be added to the blockchain and an associated instruction to add the transaction to the blockchain; convert each pending data object and pending transaction object to a permanent data record by appending the pending data record to the blockchain (for example, sending each pending data object and transaction object to a distributed ledger node for storage in a blockchain record); and generating a report showing the updates to the blockchain.

The invention is based on distributed ledger technology which uses blockchain technology to manage data, thereby advantageously facilitating consensus without requiring that any group give up control. A distributed ledger is a dynamic database that exists across several locations or among multiple participants. A distributed ledger is decentralized to eliminate the need for a central authority or intermediary to process, validate or authenticate transactions. Because the data record is not controlled by any one party, the data is held by all parties simultaneously and each party can verify or take action based on the data, without being able to unilaterally change the data in the blockchain. Consequently, the invention provides a neutral disinterested platform for participants to access data in a blockchain. The invention is facilitated by a blockchain that tokenizes the information itself, rather than any physical item like collateral.

The invention has the further advantage of providing a system that does not require any dramatic change in the existing day-to-day activities of the parties involved. Documents filed in a repository (such as but not limited to EDGAR, a trade industry repository, or a data room for a corporate deal) become the basis for the data in the distributed ledger, and notifications about proposed changes, for example, in the party providing lead servicing for a group of split loans, are handled automatically by the system, including identifying the parties that need to be notified upon initiation of a new transaction, tracking and recording responses, and updating, managing, and maintaining accurate records, without significant changes to standard workflows. The invention ensures that the parties are using current and readily available information, which is particularly advantageous when the parties are competitors in the marketplace and therefore reluctant to facilitate their competitors' business dealings or to provide confidential business information. The invention also automates the process of managing and prioritizing requests for changes in parties or party roles in related asset-backed securitizations so that there is minimal effort required by the parties. Further, the system will automatically execute a change proposal when a “No” vote does not block acceptance prior to the specified expiration date. In this regard, a “related securitization” is a transaction that contains a part of a common loan.

An important aspect of the invention resides in that the inventive crawler automatically extracts all of the data generated in separate transaction reporting documents via disparate contracts, and records the collected data in a ledger of a blockchain. The data crawler is a unique program or algorithm that traverses (or crawls) a repository of filed transaction reporting documents or a network location in search of particular document types, for example, prospectuses or pooling and servicing agreements relating to commercial mortgage-backed securities, at automatic intervals or upon manual trigger. Once the crawler has gathered the aforementioned documents, it searches each of the identified documents for information for inclusion in the blockchain, for example, in the form of an exhibit prepared in accordance with a custom format. After the program identifies relevant transaction reporting documents, or documents containing a blockchain exhibit within those documents, it parses the data contained in the document or exhibit and loads it onto the blockchain. The blockchain of the invention therefore provides a real-time immutable record of the parties in an asset-backed securitization and identifies how any split note in an asset-backed securitization is involved in any other asset-backed securitization. The blockchain also maintains records of how any parties in an asset-backed securitization voted with respect to any proposals such as servicing changes affecting the involved split notes. The blockchain creates a single ledger distributed across the various nodes, and from the ledger, or a counterpart offchain database, any number and type of reports can be generated. Thus, there may be any number of equally valid originals of the same data. The use of the counterpart offchain database for queries is less processor-intensive than searching the blockchain itself which requires complex decryption (or encryption) algorithms.

In an embodiment of the invention, each node of the blockchain may optionally be provided a separate copy of an offchain database, or there may be a single central offchain database used by multiple parties. Replicas or individual copies of the offchain database allows operators to use or modify the data for their own purposes, such as running queries or generating reports. Depending on the particular implementation of the invention, operators may be permitted to directly query the original offchain database or the replica of the offchain database at a particular node, or operators may need to export a copy of the offchain database to a local computer for query or report generation.

Furthermore, the distributed ledger drives the dissemination of subsequent notices to parties having responsibility for the asset-backed securities and thereby alieves the servicers, banks, trustees, and other parties in an asset-backed securitization of having to maintain and update their own records whenever another split note relating to its own split note is included in another asset-backed securitization or otherwise changes ownership. If a split note or other asset is not already found in the blockchain for a particular asset-backed securitization, the inventive crawler creates a new record for this split note using the available information and therefore manual input of such information is not necessary. The invention therefore incorporates historical offchain data with new data into the blockchain and the distributed ledger.

It may be desirable in certain embodiments of the invention to provide a counterpart offchain database. The offchain database replicates the information in the blockchain and can be searched using standard queries, for example but not limited to, using SQL (Structured Query Language) or another database system to organize and store structured data, and thereby permit queries of the offchain database which are less computationally intense that queries of the blockchain itself. In one exemplary embodiment, when data is being written to the blockchain, the same data can be written to the offchain database so that the blockchain and the offchain database are maintained in synchrony. Queries of the offchain database are computationally less intense than queries of the blockchain to thereby allow for more rapid searches and report generation.

In addition to managing records of the parties involved in asset-backed securitizations, an aspect of the invention also advantageously facilitates the ability to coordinate proposed changes which require consent from any of the involved parties. For example, the invention may facilitate proposed changes in party role, changes in the parties themselves, obtaining consent for particular actions, amendments to contracts, and other actions which may require obtaining consent from any of the involved parties. The invention may therefore forestall certain disputes among the involved parties by managing accurate, reliable records of all the parties and informing all parties of potential changes, avoiding situations where certain parties were not noticed of proposed changes, with the concomitant risks of regulatory action, loss of eligibility to do registered public offering, and potential litigation by investors. Unlike current procedures which require extensive communication between competing or disinterested parties, the invention facilitates consensus among the parties by implementing a voting system in the form of a smart contract allowing parties to accept or reject proposals. In contrast to conventional procedures which rely on consensus to approve proposed changes such as replacement parties, the smart contract provides a party proposing a change with a definitive “expiration date” so no party may thwart an otherwise valid transaction by failing to act. In this regard, the smart contract has an “expiration period” so that there cannot be a holdout party since proposals are structured to pass unless there are active dissenting votes. Such practices can be agreed to by the securitization industry participants as part of adoption of the blockchain platform and incorporated into the relevant asset-backed securitization agreements.

Such innovations are not provided by conventional methods and therefore the invention provides solutions and material advantages over the prior art.

Asset-backed securities of any type can potentially benefit from the inventive system for creating, maintaining and updating a distributed ledger that (i) tracks information regarding the underlying financial assets, including information as to ownership of assets and transaction participants, (ii) records changes of transaction parties and other information, and (iii) auto-generates of particular proposals via smart contract for review by the relevant parties, as described herein.

### BRIEF DESCRIPTION OF THE DRAWINGS

The foregoing and other objects and advantages will be apparent upon consideration of the following detailed description, taken in conjunction with the accompanying drawings, in which like reference characters refer to like parts throughout, and in which:

FIG. 1 is a schematic diagram showing typical flows in an asset-backed securitization.

FIG. 2 is a graphic presentation of how whole loans that have been split into multiple split loans may “straddle” multiple securitizations.

FIG. 3 is a schematic diagram of an exemplary embodiment of the invention showing how the invention crawls information from the EDGAR repository and enters it into a blockchain, in accordance with an embodiment of the invention.

FIG. 4 is a schematic diagram showing how a proposal for a change of service provider may use an exemplary embodiment of the inventive system.

FIG. 5 is a schematic diagram illustrating an exemplary embodiment of an architecture for carrying out the invention comprising a distributed computing platform and a blockchain component.

FIG. 6 illustrates an exemplary embodiment of the invention showing how information about the underlying loans in a CMBS transaction (or another asset-backed securitization) may be stored in a blockchain as a chain of contracts, and how each loan may be structured as a series of split notes and their associated servicing as a chain of transactions.

FIG. 7 illustrates an embodiment of an interface for a trustee or other administrator to initiate a proposal to change a servicer.

FIG. 8 illustrates an exemplary embodiment of an interface for an owner, depositor, trustee, certificate administrator, or other party to approve a proposal to change a servicer.

FIG. 9 illustrates an exemplary notice created by an administrator to automatically generate a fact-specific notice by querying the distributed ledger and populating the notice with the relevant information.

FIG. 10 provides an exemplary illustration of a report showing that a change in servicer has been effected and providing the identity of the current parties of each split note in a securitization. The time stamp in the left column provides a running record of changes to the data, which facilities audit, reconciliation and the generation of reports of the data.

FIG. 11 illustrates an embodiment of the invention showing two split notes owned by two different owners, for entry of the current party information in the blockchain.

FIG. 12 illustrates a first step in a CMBS transaction shown in FIG. 11 in which a split note is conveyed into a CMBS transaction and certain related transaction reporting documents are filed on EDGAR.

FIG. 13 illustrates a subsequent step in the CMBS transaction shown in FIG. 12 in which the crawler retrieves information regarding the parties involved in CMBS transaction that includes the split note from related documents filed on EDGAR.

FIG. 14 illustrates a final step in the CMBS transaction shown in FIG. 13 in which a record is created in the blockchain for both split notes and a report is generated as the final step in the transaction.

FIG. 15 illustrates a subsequent step to the securitization shown in FIG. 14 in which the second split note is conveyed into a second CMBS transaction and its relevant ownership and servicing data is filed on EDGAR.

FIG. 16 illustrates a final step in the securitization of FIG. 15 in which the ownership and servicing information for the second split note is recorded in the blockchain and a report generated as the final step in the transaction.

FIG. 17 illustrates a first step in a process of proposing a change in servicer for a CMBS transaction in which two split notes are included in two separate CMBS transactions, each having a different depositor, in accordance with another aspect of the present invention.

FIG. 18 illustrates a subsequent step to the process of FIG. 17, in which the trustee of the CMBS transaction that includes the lead servicing note prepares a proposal to change the servicer for the CMBS transaction and its underlying assets.

FIG. 19 illustrates a subsequent step to the process of FIG. 18, in which the computerized system locates the owners of each split loan that is part of the related whole loan and sends a request for approval of the change of servicer to each of the owners thereof.

FIG. 20 illustrates a subsequent step to the process of FIG. 19, in which one of the two depositors approves the proposal to change servicer.

FIG. 21 illustrates a subsequent step to the process of FIG. 20, in which the second of the two depositors chooses not to take any action in connection with the proposal to change servicer.

FIG. 22 illustrates a subsequent step to the process of FIG. 21, in which a servicer replacement application reviews the responses to the proposal to change servicer.

FIG. 23 illustrates a final step to the process of FIG. 22 in which the servicer replacement application records a transaction in the blockchain with the responses to change servicer and generates a report with the result of the voting.

### DETAILED DESCRIPTION OF THE INVENTION

Data Gathering

One aspect of the present invention is directed to a system that can track and update information related to notes, loans, and other financial assets underlying asset-backed securitization transactions and transactions themselves using a data crawler and a distributed ledger.

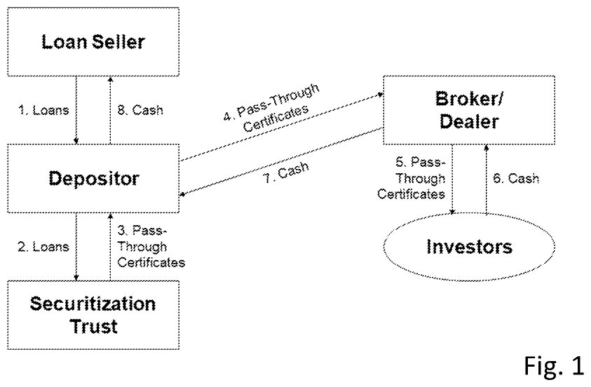

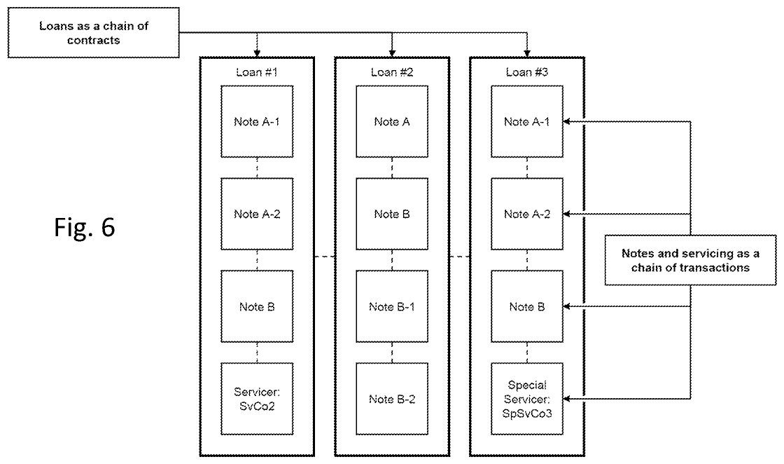

As exemplified in FIG. 1, the crawler is a program or algorithm that traverses (or crawls) a public or private repository of regulatory or other filings or submissions, or a network location, in search of particular document types, for example, prospectuses, pooling servicing agreements or trust and servicing agreements, at automatic intervals or upon manual trigger. Once the crawler has gathered the aforementioned documents, it searches each of the documents for a custom blockchain exhibit format or for particular information. After the program identifies particular documents or a blockchain exhibit format within those documents, it parses the data contained in the document or the exhibit and loads it onto the blockchain (FIG. 6).

In one embodiment, the crawler generates a crawler library of data objects (as further discussed below). In the discussion below, the terms “crawler”, “crawler program”, and “data crawler” are to be understood as being equivalent.

In one embodiment of the invention, the system starts with a custom designed blockchain exhibit to be included as an addendum, exhibit, attachment, or other part of a transaction reporting document included in a repository. In one embodiment, the filing may be a prospectus, a pooling and servicing agreement, a trust and servicing agreement, a Form 424B or a Form 8-K and the repository is the EDGAR repository. In other embodiments, the transaction reporting document or the custom blockchain exhibit may be located in an industry-sponsored repository or saved to a network location. The custom blockchain exhibit structures the specified data for the inventive system in a machine-readable format.

A blockchain exhibit may have any kind of format, including but not limited to TXT, CSV, XLS, XML, DOC, HTML, PDF, or RTF format. An exemplary embodiment of a blockchain exhibit is shown below, and consists of a series of document fields and the corresponding response.

Exhibit BCD to Pooling and Servicing
Agreement Blockchain Note Data

| | |
|---|---|
| Note/Loan ID | |
| Note Name | Bennett Valley |
| Note Number | A |
| Owner | NBDN Trust 20-23-4 |
| Depositor | North Bank Depositor NA |
| Trustee | Blue National Trust Company |
| Servicer | Alpha Servicing LLC |
| Special Servicer | Jupiter Special Servicing LLC |
| Lead servicing note | No |
| Note/Loan ID | |
| Note Name | Bennett Valley |
| Note Number | B |
| Owner | Circle Bank Owner NA |
| Depositor | |
| Trustee | |
| Servicer | |
| Special Servicer | Yes |
| Lead servicing Note | |
| BCNDend | |

In the exemplary blockchain exhibit above, the loan “Bennett Valley” consists of two separate split notes, A and B, each owned and administered by different parties. For ease of illustration, the loan in the blockchain exhibit has been split into only two notes. An empty field in the blockchain exhibit, for example, Loan/Note ID in the exemplary exhibit above, indicates an instruction to the crawler to create a new entry for the loan and note in the blockchain since the loan does not yet exist in the blockchain. The Loan/Note ID will be used to identify the unique loan recorded on blockchain from which the split notes were created. In the exemplary blockchain exhibit above, the first note A has been securitized while the second note B has not been securitized. The blockchain exhibit may contain specific indicia so that the crawler may identify the exhibit as being intended for crawling in accordance with the principles of the invention. For example, the blockchain exhibit data may start with “Blockchain Note Data” and end with “BCNDend”, as exemplified above. In other exemplary embodiments, as in the example above, the exhibit data may start with a specific string of characters such as “% #StartBlockchainExhibit #%” and end with “% #EndBlockchainExhibit #%”. These strings may be written in “hidden text” or other machine-readable characters not visible (or visible) to the unaided human eye.

In another embodiment of the invention, the crawler parses existing language in the transaction reporting documents to find the specified data for inclusion in the blockchain and distributed ledger. For instance, in order to derive the day of the month that is the determination day for payment distributions, the crawler may be instructed to look for a paragraph that starts with or contains “Determination Date” and then check to see if the paragraph includes the number 6, 9 or 11. In other embodiments, the crawler may use AI or machine learning to identify data in a transaction reporting document or blockchain exhibit, for inclusion in the blockchain and distributed ledger.

In order to reduce the number of documents or files to be scanned or processed, or when searching for blockchain exhibits in the repository, the crawler can filter documents via particular parameters. For example, when searching for CM BS filings in EDGAR, the crawler may narrow its search using particular categories, such as Standard Industrial Classification (SIC) (e.g. 6189 for asset-backed securities) and form type (e.g. 8-K for pooling and servicing agreement or Form 424B for prospectus). In other embodiments, the crawler may reduce the scope of the search to specific proper names (e.g. legal name of the depositor/registrant) or industries. Such filters can help reduce the amount of network traffic and improve efficiency by limiting the crawling to a smaller set of potentially relevant documents.

When searching for blockchain exhibits in transaction reporting documents, the crawler looks for a phrase or data string indicating the start of a blockchain exhibit and then begins parsing data. The crawler stops parsing data when it reaches a phrase indicating the end of the blockchain exhibit. Data includes information about the split loan owner, depositor, servicer and special servicer of the split note as well as whether or not the note is the lead servicing note for the whole loan. The data included in the custom blockchain exhibit will depend upon the particular implementation of the invention, and the system may require certain fields such as owner name in order to maintain consistency of data. To reduce the possibility that errors in information input into the blockchain exhibit will result in extraneous contracts, the system may include built-in data verification, which may include spellcheck, a lookup function to compare names with known names, and logic features to identify other errors. The system may also use AI or machine intelligence to identify information for inclusion in the blockchain or distributed ledger.

In one embodiment, data collected by the crawler is processed using a custom library which produces actions including user look up, contract lookup, creation of contracts on the blockchain and/or the writing of transactions on the blockchain.

When determining whether to write a new transaction, the crawler will assess whether a Loan/Note ID exists. If a Loan/Note ID for a split note does not exist, the crawler will create a unique Loan/Note ID for the whole loan. The crawler looks at a database of whole loans on the blockchain (in one embodiment, via an offchain database) to see if a contract for the whole loan has been created on the blockchain. If no contract has been created for the whole loan, the crawler will access a smart contract function via an API to create a new contract on the blockchain. Once the contract has been created or if a contract for the whole loan has already been created, the crawler will access a smart contract function via an API to write a transaction indicating that the split note exists and is associated with a specified whole loan. The API function used depends on the state of the split note. For example, if the split note is privately held but not yet securitized (e.g., it has an owner but no depositor, trustee, servicer or special servicer), the crawler will use a function called “Create Non-Securitized Note”, but if the split note is securitized (e.g., it does have a depositor, trustee, servicer and special servicer), the crawler will use a function called “Create Securitized Note.”

If the data does include a Loan/Note ID, the crawler will find the indicated contract and access a smart contract function via API to write a new transaction with the data provided in the exhibit. The primary action in this case is a smart contract function called “Make Note Securitized,” which can have ramifications on how the data is interpreted in the offchain database and at the application layer (software that exists outside the smart contracts).

The crawler may also have alternative configurations, including data lookup or data entry features or coding, consistent with the invention.

A report on the state of each whole loan and split note may be generated based on the data in the offchain database as this is less computationally challenging than querying the blockchain. Transactions are parsed to show the most recent information as well as the state of servicing for the whole loan. Smart contracts may be used for consistent treatment of the roles of the various parties. In another embodiment of the invention, a smart contract may be used to assign lead servicer and special servicer roles. A smart contract may include the following exemplary parameters:
A. If a split note is designated as the lead servicing note for the related whole loan, then the servicer and the special servicer for the securitization that holds that split note will be the servicer and the special servicer for the whole loan.
B. If the lead servicing note has not been securitized, the servicer and the special servicer for the first split note in the whole loan to be securitized will be the servicer and the special servicer of the whole loan on a temporary basis until such time the lead servicing note is securitized.
C. If the lead servicing note becomes securitized, then the role of servicing and special servicing will “shift” to the servicer and the special servicer of the now securitized lead servicing note.

Using this type of smart contracts prevents more than one split note in a loan being designated as lead servicing note.

In yet another embodiment, the crawler uses two custom object libraries, a crawler library and a data object library, to process documents filed in a public repository (such as but not limited to EDGAR) and to write information contained in those documents to the blockchain.

The two custom object libraries may be understood as tools that are used by a master program to process data. Each library is composed of a series of functions having an end goal of creating an in-memory object that represents the data that has been obtained from the blockchain exhibits contained in documents in the repository.

The following series of fourteen steps exemplify one embodiment of how the crawler program accesses information from a repository and stores it in a blockchain. Although the steps are exemplified using blockchain exhibits attached to transaction reporting documents in the EDGAR repository, as discussed previously the invention is not limited to working with EDGAR data and the principles of the invention may be used to access data from any collection of documents in a repository in accordance with the principles of the invention. The crawler may parse the repository documents themselves or it may parse a customized blockchain exhibit as discussed herein. In addition, the steps may be conducted in any appropriate order. The data the crawler will extract from the documents will depend on the particular implementation of the invention, and particular types of data are exemplified below.

Steps 1-9 describe the events that may take place within the crawler library. The goal of the crawler library is to generate in-memory objects that will be passed to the data object library for further processing. Steps 10-12 describe the events that take place within the data object library. The goal of the data object library is to generate a collection of in-memory data objects that will make the necessary web service calls to add transactions to the blockchain. The remaining steps 13 and 14 may be performed by the main crawler program. As discussed above, the crawler may locate data to be included in the blockchain by identifying a custom blockchain exhibit attached to a transaction reporting document in the repository, or the crawler may locate the data for inclusion by traversing the repository documents themselves and parsing the specified data from the documents.
1. Construction of a URL for a daily EDGAR master index file;
2. Identification of file names in master index file;
3. Identification of accession numbers in file names;
4. Identification of CIK numbers in accession numbers;
5. Construction of index header URLs;
6. Identification of an SIC code in each index header;
7. Identification of a list of HTML files in each index header;
8. Identification of a blockchain exhibit data in HTML files found in previous steps or otherwise read or parsed by the crawler from identified transaction reporting documents;
9. Construction of a crawler object using the data found in steps 1-8. Each crawler object represents a single document filed in EDGAR;
10. Passage of the collection of crawler objects as a parameter to the data object library for further processing;
11. Traversal through the collection of crawler objects by the data object library and using the data found within them to generate a collection of data objects, each representing a transaction that needs to be added to the blockchain;
12. Review of the data objects containing the EDGAR document information gathered by the crawler objects plus the web service calls needed to add the EDGAR data to the blockchain;
13. Traversal through the data object collection by the main crawler program and execution of all of the web services calls attached to each object to thereby add the transactions to the blockchain; and
14. Creation of a report by the system showing the updates to the blockchain.

In order to maximize throughput and minimize the number of documents to be examined, the crawler may search the repository for documents in particular industry classifications or for particular document types, as previously discussed. This is particularly beneficial when a repository organizes the documents by date. For example, the EDGAR archive is a series of web directories that are organized by year and quarter. Instead of reviewing each document in the desired classifications of the repository, in certain embodiments the crawler may be able to traverse an index of the repository to locate documents, rather than traversing the documents themselves, in order to potentially further reduce the number of documents to be reviewed. The crawler program may traverse these directories by programmatically building web links that correspond to the specific EDGAR archive directories that contain the desired targeted documents. In one exemplary embodiment, the program begins by building a web link to access a master index file, for example, the daily EDGAR master index file located in the “https://www.sec.gov/Archives/edgar/daily-index/” directory. The EDGAR convention for the master index file location is as follows: https://www.sec.gov/Archives/edgar/daily-index/CURRENT YEAR/CURRENT QUARTER/MASTER FILE NAME

The https://www.sec.gov/Archives/edgar/daily-index/ portion of the above URL is a reference to the main EDGAR archive file path according to the EDGAR documentation. The CURRENT YEAR and CURRENT QUARTER parameters are programmatically calculated by the crawler based on the current date. The MASTER FILE NAME is built by the crawler using the convention “master.CURRENT DATE(yyyymmdd).idx”, where the CURRENT DATE parameter in yyyymmdd format is programmatically generated based on the current date.

The EDGAR master index files are generated daily and contain information about the EDGAR documents that were filed the previous day. In one embodiment, the crawler program reads the master index file and captures information about Form 424B or Form 8-K documents only, instead of crawling the entire repository. The information collected may be processed using a custom crawler library that generates a crawler object. The crawler object represents an EDGAR archive search results e.g., a Form 424B or Form 8-K document listing. The crawler objects may then be used to build a custom data structure that will facilitate the processing of the blockchain exhibit data. In an exemplary embodiment, the following data may be captured from the master index file:

| Master | |
|---|---|
| Index Field | Field Description |
| CIK | Central Index Key- A unique numerical identifier |
| | assigned by the EDGAR system to filers (registrants) |
| | when requesting permission to make filings to the SEC |
| Company Name | The company name |
| Form Type | SEC form type (prescribed by the SEC) |
| Date Filed | The date the document was filed in EDGAR |
| File Name | The file archive path to the EDGAR document |
| SIC | Standard Industrial Classification -A system for |
| | classifying industries by a four-digit code. |

In this exemplary embodiment, the CIK and File Name are of particular interest since they are used to drill down further into a specific Form 424B or Form 8-K document's archive directory. The File Name is parsed by the crawler program to extract the EDGAR Accession Number. The Accession Number is a unique identifier assigned automatically to an accepted submission by the EDGAR Filer System. The Accession Number is composed of the CIK number, two-digit current year and the number of the sequential count of submitted filings for that particular CIK.

Once the master index file has been read by the crawler, in this embodiment the program will continue on to the next step which is generating the index header paths. The index header may be similar in form to a table of contents for the Form 424B or Form 8-K filing that contains the Standard Industrial Classification (SIC) code and the names of all of the documents associated with the filing. The index header path may be built by the crawler. One exemplary convention may be: https://www.sec.gov/Archives/edgar/data/CIK/ACCESSION NUMBER/ACCESSION NUMBER FORMATTED-index-headers.html

In this exemplary embodiment, the CIK and ACCESSION NUMBER parameters derive from the master index file that was processed earlier. The ACCESSION NUMBER FORMATTED parameter is a version of the Accession Number that separates its different components using a dash (-). Once the index header path has been generated, the crawler may access the path and begin reading the index header document itself. The crawler may then search the index header document for the SIC code and any html files listed in the associated documents section. The crawler then stores in the crawler library the SIC code and the list of html documents found in the crawler object. In this embodiment, the crawler object generation is considered completed once the SIC and html document search has been finalized.

In this embodiment, a second custom library (a data object library) may be used to generate data objects. The data objects use the crawler objects to generate the web API calls that are needed to feed the blockchain exhibit data to the blockchain. The data object library works by creating data objects that extract the blockchain exhibit data from the html documents list attached to each crawler object. The data objects will access each html document in the list and search for the custom blockchain exhibit format. If the custom blockchain exhibit format is found, the data object will extract data from it and use that data to build the appropriate web API call. The following chart displays an exemplary list of data points that are captured from the custom blockchain exhibit:

| FIELD NAME | DESCRIPTION |
|---|---|
| Loan/Note ID | Contract ID - Note ID |
| Loan Name | Name of the loan |
| Note Number | Number of the note |
| Owner | Owner of the note |
| Depositor | Depositor of the note |
| Trustee | Trustee of the note |
| Servicer | Servicer of the note |
| Special Servicer | Special Servicer of the note |
| Lead Servicing Note | Is lead servicing note? Y/N |

In this embodiment, a data object will process all of the data points it has consumed and decide whether to compose a web API call to either create a “non-securitized note” or convert a “non-securitized note” into a “securitized note” in the blockchain. The generation of both calls involves lookups using an offchain database to confirm Owner, Depositor, and Trustee users. In addition, the securitization state is determined based on whether valid users were provided for the Depositor, Trustee, Servicer, and Special Servicer fields. If all of the aforementioned fields have valid users attached to them, then the split note is considered “securitized”; otherwise, the split note is considered “non-securitized”.

The generation of the “create a non-securitized note” call in this embodiment is triggered when the value for Loan/Note ID is blank. The data object interprets this as a signal to generate both a new contract ID and a new note ID. The contract ID is generated through the “generate new contract ID” web API call. One contract ID is generated for each unique whole loan found in the blockchain exhibit. For example, if there are three different split notes associated with the “Madison” whole loan, those three split notes will all have the same contract ID. Once the “generate new contract ID” call is made, the new contract ID becomes available for use. The note ID is generated via a custom ID generator in the offchain database. Once both pieces of data are generated, they are stored in the data object. The object is then flagged for creation and an appropriate web API call is generated.

In this embodiment, the generation of the “convert a non-securitized note into a securitized note” call is triggered by the presence of a value in the Loan/Note ID field. The Loan/Note ID field is parsed into its two separate components, contract ID and note ID. Both contract ID and note ID are verified against the offchain database. Once both pieces of data have been verified, the object is flagged for conversion into a “securitized note” and the appropriate web API call is generated. The generation of a data object is considered completed once the web API calls have been generated for that object. The chart below exemplifies the fields that are may be used for each web API call.

| | | Required For Convert |
|---|---|---|
| Web API | Required For Create Non- | Non-Securitized Note To |
| Call Fields | Securitized Note Call | Securitized Note Call |
| _id | YES | YES |
| _isSecuritized | NO | YES |
| _ownerString | YES | YES |
| _depositor | YES | YES |
| _trustee | YES | YES |
| _servicer | YES | YES |
| _specialServicer | YES | YES |
| _loanName | NO | YES |
| _noteNumber | NO | YES |
| _isLeadNote | NO | YES |

As each data object is created, it is stored in a custom data structure. After all of the crawler objects have been processed and all of the data objects have been created, the crawler program traverses through the custom data structure and executes all of the web API calls that are attached to each data object, thereby loading the information collected from EDGAR into the blockchain in this exemplification.

In some embodiments, the blockchain may contain a record of all parties for a particular whole loan. Alternatively, the blockchain may contain a record of only data for split loans/split notes, and records of non-securitized notes are not included in the blockchain.

Updated data such as servicing information may be copied to the offchain database and appear in a report generated at the end of the method to show the changes. The offchain database replicates the information in the blockchain and can be searched using standard queries, for example using SQL. Searching the offchain database instead of the blockchain avoids the need to decrypt blockchain data and is less computationally intensive.

When implementing the present invention, the issue of integration of legacy data arises. Legacy data refers to the data of asset-backed securitization transactions commenced or completed before the adoption of the present invention. Such data may not be captured by the crawler if a custom-formatted blockchain exhibit containing the specified data was not deposited in the repository, or if the transaction reporting documents have not been parsed by the crawler. This legacy data may be added to the blockchain by crawling the transaction reporting documents themselves to parse the desired information, or by generating custom-formatted blockchain exhibits for the desired transactions and causing the crawler to parse and incorporate the data into the blockchain. In further embodiments, automated systems such as AI or machine learning may be used to identify data for inclusion in the blockchain. Any of these systems may or may not include human verification of data. These generated blockchain exhibits may be saved in a network location to facilitate crawling by the crawler. Alternatively, the data may be manually entered into the blockchain, for example, using a data entry interface (not illustrated).

In certain embodiments, a reward may be granted as a financial incentive for accomplishing particular activities associated with the invention. For example, a reward may be granted for completion of verification activity, such as verification of manual entry of legacy data. A reward may have any form, such as (but not limited to) a monetary payment, credit or voucher for use towards future charges, or a rebate of paid fees. A monetary reward may be in the form of cash, virtual currency, token, cryptotoken, digital currency, cryptocurrency, or any other currency or consideration which may be used for tender of payment. With respect to cryptocurrency, any cryptocurrency generated during use of the invention may be retained or distributed by an administrator, trustee, bank, or other party in accordance with any pre-arranged agreement.

Coordination of Changes in Parties or Party Role

Another aspect of the present invention is directed to systems and associated methods which facilitate changes in securitization transaction parties or party roles using the inventive distributed ledger technology. The system may be designed together with the previously-described crawler to form a unitary system, or as a separate system which has its own hardware, interface, and setup, as exemplified and discussed above.

Cloud implementations of the present invention as further described herein are also possible. For example, embodiments of the invention may be implemented using cloud computing services such as Microsoft Azure and IBM Cloud Compute. Such cloud computing services may comprise software for building, testing, deploying, and managing applications and services. For example, the cloud computing services may comprise features such as user sign-on and authentication functionality; a user interface client which permits users to interact with the invention; a record creation module for generating records to be saved; a blockchain module for creation of blockchain-based apps and smart contracts to obtain cryptographically-immutable ledgers; a reporting module for generation of reports for users and administrators; and a notification module for generation and sending of notifications to designated recipients, for example, using E-mail or via a network such as the Internet. The cloud computing services may also comprise tools for preparation of apps or applications for particular tasks such as template-driven construction of notifications In an embodiment of the invention, such tools may be prepared using Azure Logic Apps. Other embodiments of distributed computing systems are within the scope of the present invention. Examples of blockchain platforms that may be used with the present invention include Ethereum, Multichain, Hydrachain, and IBM Blockchain. Other exemplary blockchain platforms will be evident to those of skill.

For ease of discussion, this aspect of the invention will be described and exemplified with reference to changes in securitization transaction servicers although the principles of the invention can be applied to any changes in agency or administrator requiring approval from one or more parties in a securitization transaction.

Automatic Re-Designation of Lead Servicing Role

Generally, the holder of a split note that is designated as the “lead servicing note”, that is, part of a whole loan, is charged with the responsibility of servicing the entire whole loan for the benefit of all of the holders of related split loans. From time to time, the split note designated as the “lead servicing note” is not the first split note in the group to be securitized, which necessitates the first securitization to hold one of the related split notes to provide “lead servicing” on a temporary basis until such time the “lead servicing note” is securitized, at which point “lead servicing” will “shift” to the securitization that holds the “lead servicing note.”

In an exemplary embodiment, if the first split note that is recorded on the blockchain is not the “lead servicing note”, the system records such split note as the lead servicing note on a temporary basis. When the actual lead servicing note is subsequently securitized, the system (i) automatically updates the blockchain record reflect that newly securitized split note as the “lead servicing note” and removes the “lead servicing” status from the first split note and (ii) automatically generates E-mail notifications or any other form of notice to all split loan parties notifying them of the change in servicing responsibility from the first split note to the actual lead servicing note.

Mechanism for Replacement of Servicing Party

Investors in CMBS transactions typically have certain rights, including the right to replace the special servicer with another special servicer. Because the lead servicing note controls the servicing of the whole loan, portions of which may be evidenced by split notes included in a number of different CMBS transactions, each of which imposes on the applicable depositor an obligation to file a Form 8-K to report a change of servicer, a servicing transfer by the lead servicing note must be communicated and agreed upon by the owners of the related split notes.

In an exemplary embodiment, in order to commence the process of a change in servicer of the whole loan, the applicable trustee may initiate the change by accessing a trustee interface to the invention. To facilitate the process and reduce data entry errors, trustees may be presented with a list of CMBS transactions where they are listed as the trustee. The trustee selects a CM BS transaction, enters the name of the proposed replacement servicing entity, indicates the role they are proposed to fill (for example, servicer or special servicer) and indicates a date on which the will be recorded on the blockchain (the “effective date”). Once this data entry is complete, the trustee submits its proposal for delivery to the relevant parties for approval as further discussed herein.

When a proposed change in servicer is submitted, the system identifies each split note included in the CMBS transaction that is either the lead servicing note in its whole loan or is acting as lead servicing note in its whole loan. For each of these loans, the system then identifies the owners of privately-held notes, or in the case of securitized notes, the depositor for the related securitization, and sends these parties a notification, which may be by E-mail or any other form of communication, with information about the proposed change in servicing. The identification of the owners or other parties may involve a lookup function which accesses the blockchain and/or offchain database to retrieve the name(s) of the relevant parties. Querying the offchain database is not as processor-intensive as querying the blockchain and consequently provides for faster queries or generation of reports.

The notification may include a hyperlink that the owner(s) or depositor(s) use to access a webpage where they have the option to acknowledge, object to, or abstain from acknowledging the proposed change in servicing. As long as no owner or depositor objects to the change in servicing, it will be recorded as a transaction on the blockchain on the earlier of the date on which each owner and depositor has assented to the change or the effective date selected by the trustee. Updated servicing information may be copied to the offchain database and appear in the report, thus not allowing an owner's inactivity from prohibiting a change in party to proceed. Agreement to permit voting on such proposals can be made by the parties during the initial document drafting process as a required condition.

In another embodiment, the system may allow proposals to be voted on with a consistent set of rules for each proposal and to avoid conflicting proposals. Such rules may be agreed upon by the parties or by securitization industry participants as part of adoption of the blockchain platform so that all parties agree to the method of voting on proposals for changes in parties or party roles. In one example, the following rules may be implemented by the system, for example, as a smart contract:
1. There may only be one proposal outstanding for any role with respect to any specific loan or deal.
2. Proposals are terminated immediately when any noteholder, owner, depositor, or other stakeholder enters an objection such as a “No” vote. Following a “No” vote, a new proposal must be submitted and voted upon to subsequently effect a change in servicing.
3. Proposed changes in servicer become effective on the business day following the date on which all of the affected noteholders have recorded an acknowledgement (a “Yes” vote) or active abstention (an “Abstain” vote). In this context, “Abstain” means an affirmative reply to the proposal indicating the party will not vote “Yes” or “No”, and is not a passive abstention from voting or a non-action which is deemed an abstention.
4. If 15 days (or another predetermined number of days) have passed without a “No” vote, the proposed change becomes effective on the next business day even if not all of the noteholders have voted.

Various kinds of fee arrangements are possible with the invention. For example, a fee may be charged for use of the invention up front when receiving the asset-backed loan, or access to the blockchain database may be provided via a local or remote device upon payment of a fee. Other fee arrangements are possible and within the scope of a person of skill.

Determination of Timeliness of Filings

The present invention is also capable of determining timeliness of filings of transaction reporting documents with a repository. That is, the invention can determine whether a transaction reporting document was filed within a required period of time after a reportable event or during a report period. At present, no method exists to automatically make such determination, and instead, each filing must be retrieved, the filing date reviewed, and then compared against the applicable filing due date, which must be calculated to account for the applicable business day convention. As the task of verifying timeliness of filings can be involved and time-consuming, an embodiment of the data crawler of the present invention can be used to facilitate this review to rapidly assess timeliness and to provide this information to the user, for example, in a report which may be printed, saved, or displayed on a computer screen.

This aspect of the present invention will be described by reference to the EDGAR repository for consistency of discussion, although the invention can be equally performed with transaction reporting documents filed with another public or private repository, as discussed elsewhere.

In an embodiment of the invention, the crawler searches the repository (for example, EDGAR) for a unique identification code (for example, a CIK number, tax ID number, or company legal name) of each issuing entity formed by a registrant; identifies all of the filings made by such issuing entity within a pre-defined reporting period; and captures information such as the form type, items reported, and filing date, and saves this information in the blockchain of the distributed ledger. When it is desirable to evaluate the timeliness of the filings, these filing dates may then be compared using a timeliness application against the filing due dates for each of these form types, in order to determine if each filing was timely made. A report can be generated to provide to a user the timeliness of each filing or a summary thereof for each issuing entity.

For example, Form 10-D is required to be filed within 15 days after the related distribution date. For an issuing entity with a distribution date of the 5th of each month, this would be a filing due date of the 20th, subject to the SEC's business day convention, which means the filing due date would be the next business day if the 20th were a Saturday, Sunday or SEC holiday. The process for searching for Form 8-K in the repository is similar, although the crawler may also extract the Item Number(s) reported within the Form 8-K, which determines the applicable filing due date. Such information may be stored in the blockchain of the distributed ledger or an offchain database, and reports may be generated indicating, for any registrant, if each of its issuing entities has timely filed all of its required filings.

The timeliness application may comprise a function that determines whether a document was timely filed by comparing the filing date to a calculated due date. For example, the calculated due date may be determined using an algorithm or spreadsheet function that calculates the filing due date based upon the distribution date. The filing due date may need to be adjusted as necessary to account for factors such as (a) the number of business days within the reporting period or reporting interval, and (b) the business day convention for the distribution date to reflect holidays such as bank holidays. For example, some transactions consider bank holidays as non-business days, while other transactions consider bank holidays as well as any day the New York Stock Exchange is closed as non-business days (the difference, in most years, is typically Good Friday). Each issuing entity may be assigned a particular method of calculating the filing date upon review of these defined terms. Alternatively, the timeliness application may obtain the definition of “Distribution Date” from the blockchain and identify the calendar day (e.g. 5th of each month) and business day convention (e.g. bank vs. NYSE), and then automatically apply the appropriate filing due date calculation function.

In certain embodiments of the invention, the documents filed with the repository may themselves contain information for calculating filing due dates. For example, if there is a servicing transfer disclosed in a Form 8-K, the timeliness application may compare the effective date of the servicing transfer (reported on the blockchain) to the filing date of the 8-K that includes an Item 6.02 (Change of Servicer) report to calculate if the two dates were within 4 business days (SEC business day convention) of each other. Other uses of the invention will be apparent to those of skill in the art. In certain embodiments, it may be desirable for the invention to flag particular filings for manual review if the filings appear to have been submitted outside a particular interval of days. For example, if a filing date in the blockchain is more than a particular number of days before or after a filing due date, e.g., 15 days, or 30 days, or 45 days, or 60 days, the invention can flag such filings for a user to review whether there is an error in the data and thereby provide a quality control check.

Push Notices

Another aspect of the present invention allows the invention to provide notifications of events to affected parties without a vote. For example, there are situations where a party to a transaction may be removed under the terms of the subject agreement, and the other depositors do not vote to approve such a change, for example, when a transaction party has the right to terminate a servicer without cause or a servicer defaults. In such instances, the other depositors will receive a notice of the event without a vote having taken place. Because the event may be reportable, the depositors may still be required to file a transaction reporting document with a repository (for example, a Form 8-K with EDGAR). However, since there is no vote, none of the parties has the ability or opportunity to vote “No” in order to delay an event, for example, to obtain more time to prepare any necessary documents to be filed. For example, if ABC Bank defaulted as Master Servicer by failing to make a required payment, a subject deal would default and terminate ABC Bank, regardless of whether the other depositors are ready to submit their respective filings. In such instances, the invention provides the other depositors with a “push notice” informing these depositors that a change has occurred, and the depositors will need to assess if they have to report this change to the repository. In other embodiments of the invention, other parties such as a depositor may initiate an action rather than directing a trustee to start the process.

In an exemplary embodiment of the push notice scenario, a Trustee (or another administrator) may log on the invention and select the affected transaction, party, and event (e.g. situations 1-4 mentioned above), for example, using dropdown menus. A push logic application locates finds the affected transaction(s) in the ledger (or an offchain database), retrieves the relevant information from the ledger and generates a notice which is then sent to the affected parties reporting the event. The notice may also inform the affected parties that the ledger has been updated and that the change may need to be reported to the repository. A report may also be generated showing that, for example, ABC Bank had defaulted and was replaced by Scotch Trust Co.

The party initiating the change may be any affected party, and therefore a trustee may not always be the initiator. For example, if the trustee were to resign or be disqualified, another party (such as a certificate administrator or a depositor) may initiate the notice, so the trustee does not have to report its own default. In most instances, a party cannot be removed until a successor has been appointed, and if no successor is found within a set period (typically 90 days), a court appoints one. Consequently, in one embodiment of the invention, a push notice may be issued as a result of a court order appointing a successor. In such instances, the trustee may follow a similar procedure to notify the relevant parties of the change. Other uses of push notifications will be evident to those of skill.

Push notices may also be sent where a non-reportable party (one whose replacement does not trigger an 8-K filing requirement) is changed, as discussed above. Examples of such parties include the custodian, operating advisor, asset representations reviewer, and servicing function participants, and potentially subservicers and subcontractors. Although replacement of such parties are not usually reportable events, it may nevertheless be desirable to include such information in the general ledger, and if such parties are removed for any reason, a push notice may be sent to the parties of the affected deals to inform them that the ledger has been updated with the new party information. Similarly, if a deal party wants to change its notice address, the party may access the invention to enter the new address and a Push Notice would go out to the Other Depositors with the new address. In this manner, the invention facilitates the parties to maintain accurate records and contact information.

### DISCUSSION OF FIGURES

The invention will now be described with reference to the Figures, wherein like reference numerals refer to like elements.

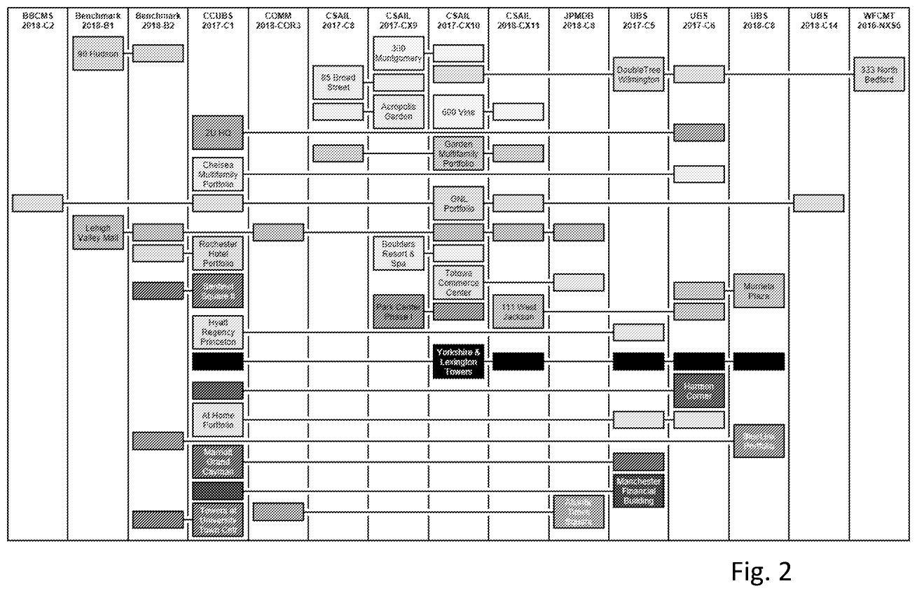

FIG. 1 illustrates a schematic diagram showing typical flows in an asset-backed securitization, and FIG. 2 is a graphic presentation of how whole loans that have been split into multiple split loans may “straddle” multiple securitizations. These figures have already been discussed above.

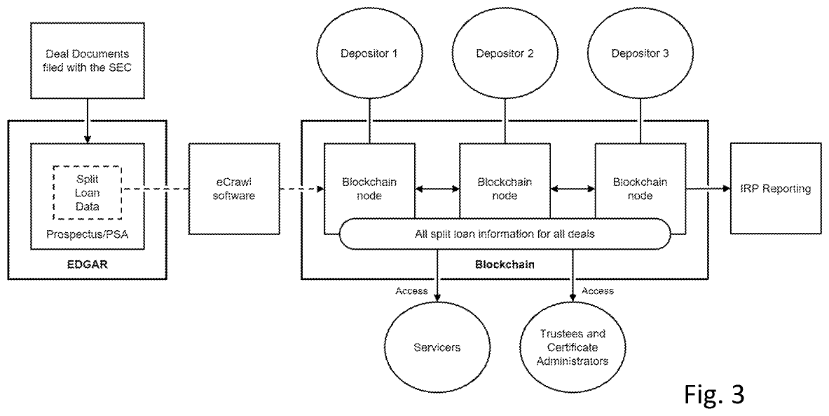

FIG. 3 is a schematic diagram of an exemplary embodiment showing how the system may crawl the EDGAR repository using the data crawler software to retrieve split loan data, parse the crawled data, and enter the data into blockchain nodes of a distributed ledger system, in accordance with an exemplary embodiment of the invention. Each of the participants (e.g., depositors, servicers, loan sellers, trustees, certificate administrators, and any other parties, hereafter collectively termed “participants” or “parties” for ease of discussion) may access this information via the distributed ledger system so as to benefit from the data acquisition.

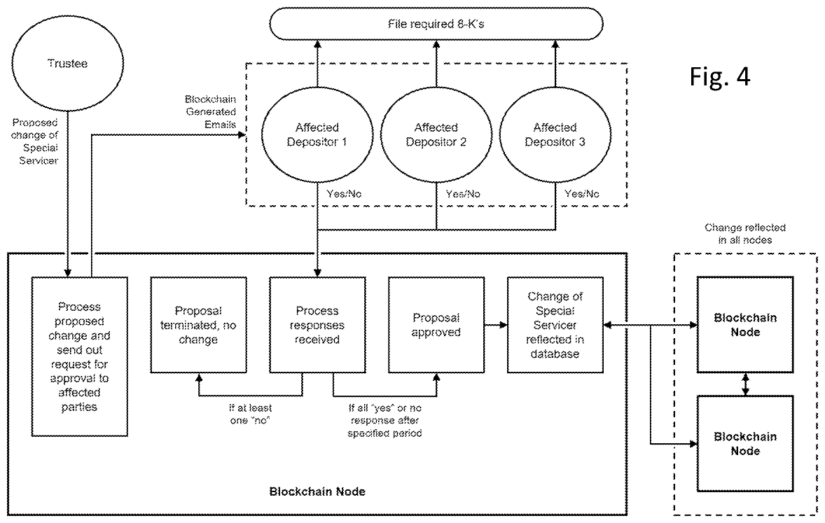

FIG. 4 is a schematic diagram showing an exemplary embodiment of how a proposal for a change of servicer may use the inventive system. In this embodiment, trustees using the system prepare a proposal and instruct the blockchain system to issue an electronic notification to the affected depositors or noteholders. The blockchain system looks up the identities of the affected parties from the blockchain database and these parties receive a proposal using electronic means such as E-mail. The affected parties have an opportunity to respond to a change in servicer by agreeing, abstaining, or disagreeing with the proposal. If the proposal is voted “No” by any party, the proposal cannot pass and the parties can discuss the proposal and resolve their issues. After the proposal has been reissued (in the same or modified form), accepted, and the results recorded in the blockchain, the parties can proceed in accordance with the accepted proposal. As shown in FIG. 4, the data added to the initial blockchain node is also copied to the other blockchain nodes in accordance with the distributed ledger technology of the present invention so that all of the blockchain nodes are in synchrony. The affected depositors or other parties may then file any necessary filings with a regulatory agency or trade group, such as the Form 8-K's exemplified in the figure.

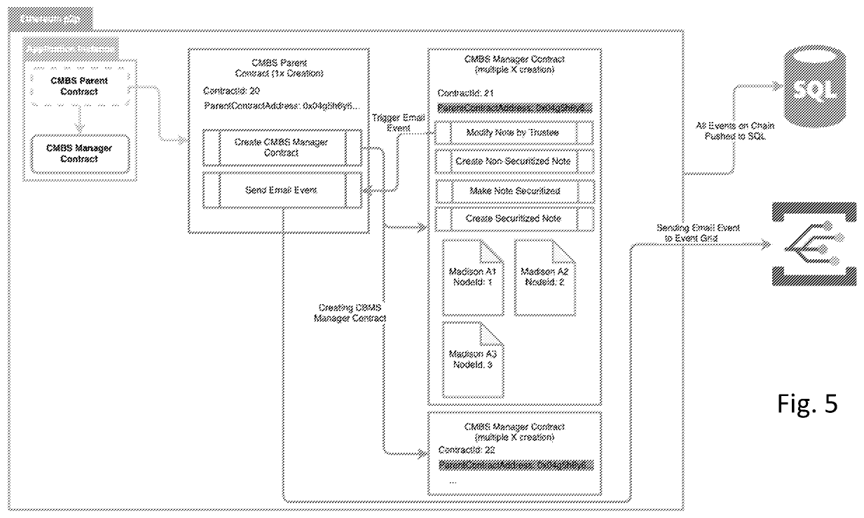

FIG. 5 is a schematic diagram illustrating an exemplary embodiment of an architecture for carrying out the invention comprising a distributed computing platform using a blockchain, with particular reference to showing how parent/child contracts may be depicted in the architecture. The parent contract contains a number of loans which are shown as child contracts, each of the contracts representing a separate note. These contracts are implemented in the blockchain as smart contracts: self-executing code on a blockchain that automatically implements the terms of an agreement between parties.

FIG. 6 exemplifies how loan information may be stored in a blockchain as a chain of contracts, and how each loan may be structured as a series of notes and their associated servicing as a chain of transactions.

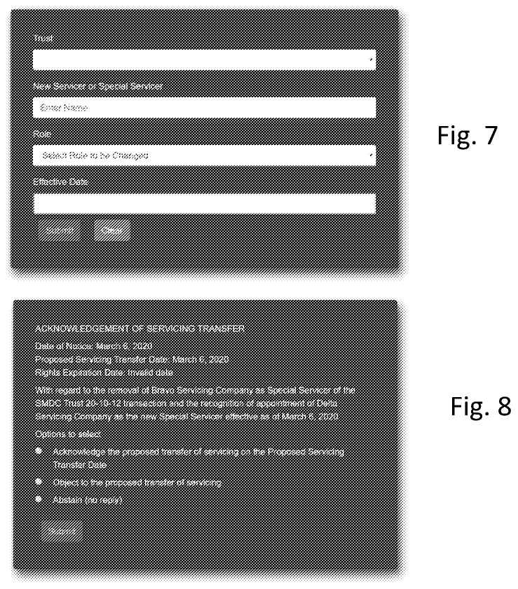

FIG. 7 illustrates an exemplary embodiment of an interface for a trustee or other administrator to initiate a proposal to change a servicer or other party. The interface may be displayed using a web browser or another program which can display and receive text and data. In this embodiment, after logging in or otherwise obtaining access to the system, the trustee is presented with an interface for entry of the name of the trust (the name of the issuing entity for a CMBS transaction), the role to be changed (servicer or special servicer in this example) and the name of the proposed replacement. The trust name may use a convention such as (Index)-(Year)-(Week)-(Sequence No.) to distinguish the various CMBS transactions, or another name or naming convention may be used. To facilitate data entry, some of the fields (such as Trust and Role, as illustrated in this Figure) may have drop-down menus to allow the trustee to make the appropriate selection. The effective date for the proposal will be the date on which the transaction will take place if there are no “No” votes. If each of the relevant parties provides an affirmative vote such as “Yes” or “Abstain” in advance of the effective date, the system may advance the date of the change to the next business day, or another date before the effective date entered by the trustee, in accordance with the logic of a relevant smart contract.

FIG. 8 illustrates an exemplary embodiment of an interface for a depositor or other party to approve a proposal to change a servicer. The illustrated interface contains three options: acknowledge the change in servicer; object to the change; or actively abstain. Selection of one of these options will send an automated response to an application in the blockchain node which will record the vote in the blockchain. Other changes, and not merely changes in servicer, can be proposed and voted on in the same manner as discussed and exemplified herein.

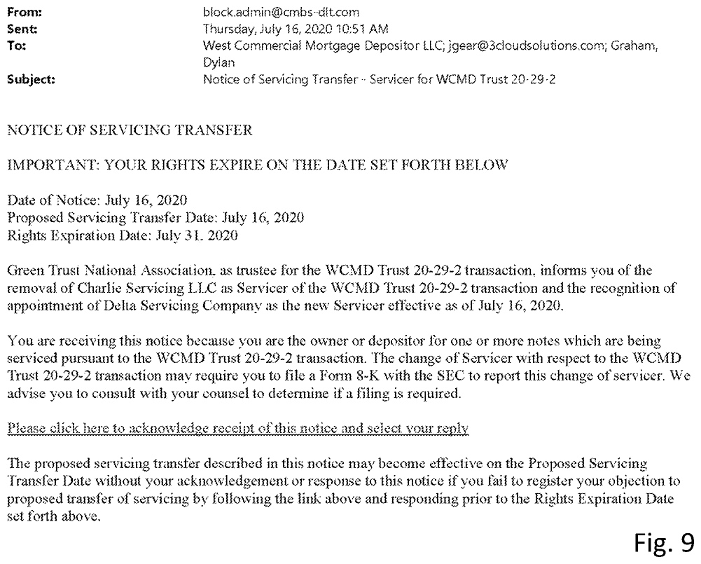

FIG. 9 illustrates an exemplary notice created by an administrator to automatically generate a fact-specific proposal by querying the distributed ledger and populating the proposal with the relevant information. The administrator may use an interface such as the interface illustrated in FIG. 7 to populate the proposal. The invention may comprise a number of previously-prepared template documents, and the administrator may select a particular template which pertains to the desired notice. After the administrator has selected the desired template and identified the correct transaction and transaction parties, the invention automatically generates the proposal and forwards the notice to the relevant parties. The invention may provide a preview of the notice to the administrator prior to sending the notice to the recipients. The templates may be updated or customized as may be desirable.

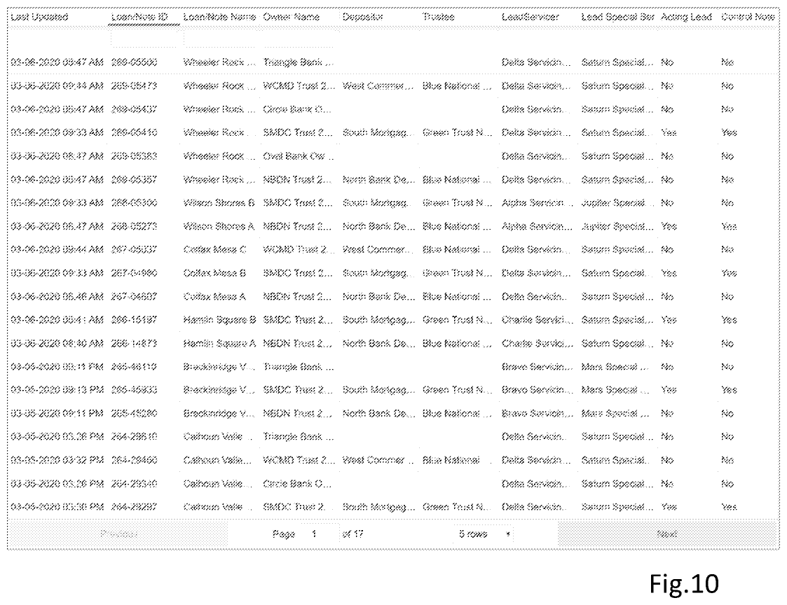

FIG. 10 provides an exemplary illustration of a split loan ownership and servicing database report showing effected changes in transaction party or party role, and providing the identity of the current parties associated with each split note (or other asset type) in asset-backed securitizations. The report identifies each separate note included in an asset-backed securitization, its owner and whether the note is privately held or is included in a securitization. The report also identifies the name of the depositor and the trustee, whether the note is a lead servicing note and the names of the lead servicer and the lead special servicer. The particular fields shown in the report, or parsed from the blockchain exhibit from a repository (such as EDGAR), will depend upon the particular implementation of the invention, but it is envisioned that the fields identified above will be typical. Once the proposal is sent to the depositors by the trustee, as discussed with reference to FIGS. 7 and 8, an application can be running continuously or periodically (e.g. daily, weekly) in the background to monitor the votes. The application can also be triggered to run manually when it is desirable to do so.

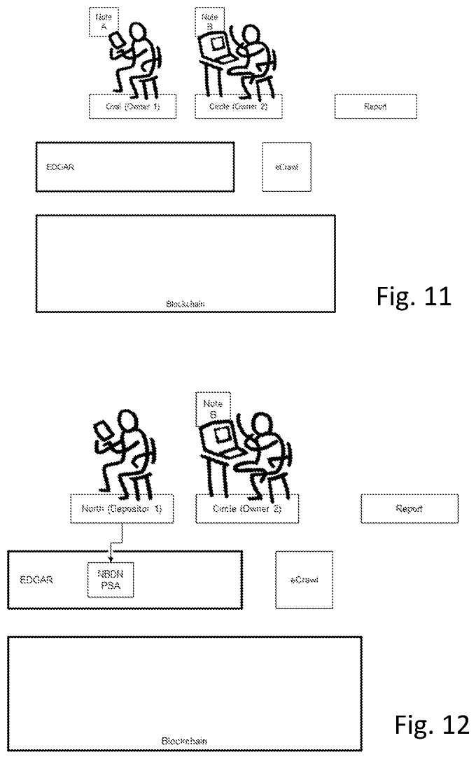

FIGS. 11-16 exemplify a process for showing how data for parties holding split notes underlying asset-backed securitizations can be entered into a blockchain of a distributed ledger, in accordance with an embodiment of the present invention. FIG. 11 illustrates an initial configuration in the process and in this example, a loan which was split into two separate notes, Note A owned by Oval, and Note B owned by Circle. In FIG. 11, these two notes are initially privately held and have not yet been included in a securitization.

In FIG. 12, asset-backed Note A, which was originally owned by Oval in FIG. 11, has been sold to North and therefore Oval is therefore no longer the owner. In FIG. 12, North deposits Note A as an underlying asset in a securitization in a transaction called NBDN and consequently becomes the depositor of the split note during the NBDN securitization transaction, and the NBDN securitization trust (not illustrated) becomes the actual owner of Note A. In this embodiment, NBDN files the relevant document with EDGAR to disclose the securitization. For example, the filed document may be a prospectus or a pooling and servicing agreement that gives information about the transaction. The prospectus or the pooling and service agreement may have a custom blockchain exhibit, as discussed herein, included in the document itself or as an attachment to the EDGAR filing. Alternatively, the pooling and service agreement may contain a data table or other information which can be read by the crawler, AI, or machine intelligence, or other means to parse the relevant data. Note B remains privately owned by Circle and is not part of the NBDN securitization.

In FIG. 13, the crawler locates the document which was filed with EDGAR in FIG. 12 concerning the NBDN securitization, and the crawler parses the information from the blockchain exhibit accompanying the pooling and servicing agreement. Because the NBDN securitization includes a split note (Note A) that is part of a whole loan which had been privately owned and therefore not yet recorded in the blockchain, in FIG. 14, the crawler writes a parent contract in the blockchain for the original loan, a child contract in the blockchain for the NBDN securitization, and separate child transactions for each of the notes: one for securitized Note A deposited by North and the second for privately held Note B owned by Circle. In the last step of the process shown in FIG. 14, the crawler generates a report showing the additions to the blockchain.

In FIGS. 11-14, Note A was included in a securitization while Note B remained privately owned. Even though Note B has not been securitized in this illustration and therefore does not need to be reported to EDGAR, the blockchain exhibit filed with EDGAR contains the state of the entire whole loan, and the report identifies the status of each of the split notes, Note A and Note B. That is, a record is created in the blockchain for both split notes and a report is generated as the final step, so that a complete record of the loan components is present in the blockchain.

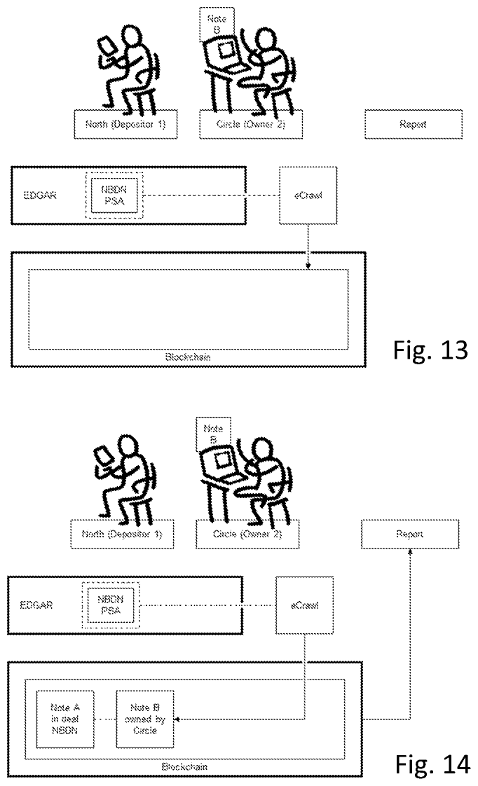

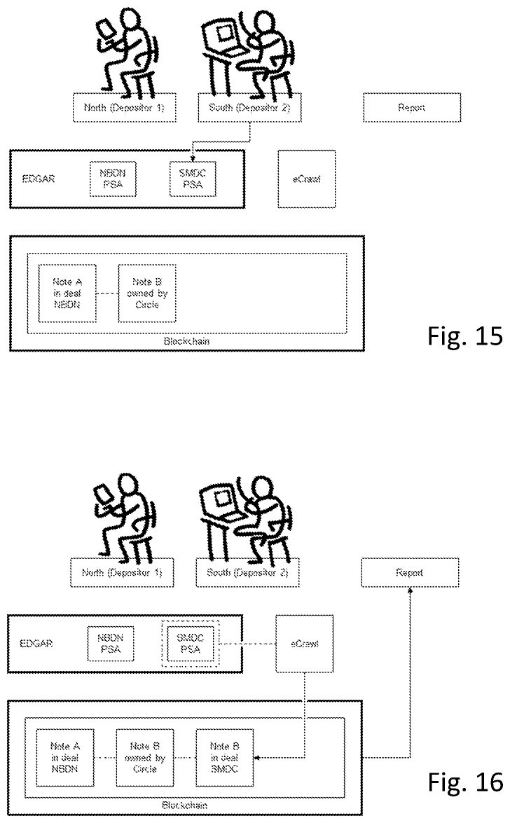

FIGS. 15-16 illustrate a continuation of the embodiment of FIG. 14 in which the second split note (Note B) is securitized, and show how the blockchain is updated with the information concerning this securitized Note B. In FIGS. 15-16, Note A remains part of the NBDN securitization transaction.

In FIG. 15, Note B has been sold by Circle to a new owner, South. South deposits its Note B in a new securitization transaction called SMDC and the SMDC securitization trust files its own pooling and servicing agreement with EDGAR, separately from the NBDN transaction. Upon securitization, the owner of Note B is now the SMDC securitization trust.

In FIG. 16, the crawler identifies the SM DC securitization as to which a new filing has been made in EDGAR. The crawler identifies the securitization data from the blockchain exhibit attached to the SMDC pooling and servicing agreement filed with EDGAR, and writes a new transaction containing this information to the blockchain. As a final step, a report is generated to reflect the most recent updates to Note B. Each of the whole loan and split notes (Note A and Note B) is visible in a user interface (not illustrated) and a user can select any split note or whole loan to obtain more information, for example, the current owner or depositor, or servicer information. NBDN and SMDC are distinct asset-backed securitizations and are only related to the extent that they each contain a split note (Note A or Note B) created by splitting a large whole loan into two respective parts.

FIGS. 17-23 illustrate a process of proposing a change in servicer for an asset-backed securitization which also has the effect of changing the servicer for the whole loan encompassing Note A and Note B, as securitized in FIGS. 11-16, in accordance with an exemplary embodiment according to another aspect of the present invention. Although FIGS. 17-23 exemplify a proposal for a change in servicer, any other kinds of proposals, such as changes of other transaction parties or other administrative roles, can be effected using the inventive system. Exemplary applications used in this process may include a trustee user interface for initiating a proposal for a change in servicer; a depositor user interface to acknowledge or object to a change in servicer; a notification generation application which can send notifications to the relevant depositors; and a servicer replacement application that monitors the state of the proposed change in servicer and will write the change to the blockchain when the change should become effective. A blockchain node manages the steps of the proposal.

FIG. 17 illustrates a first step in a process of proposing a change in servicer. In this illustrated embodiment, there are two depositors, North and South, each having deposited into its own securitization one of the two securitized split notes, Note A and Note B. Green is the trustee for the SMDC securitization of Note B shown in FIGS. 15-16. The securitization transactions have already been written to the blockchain.

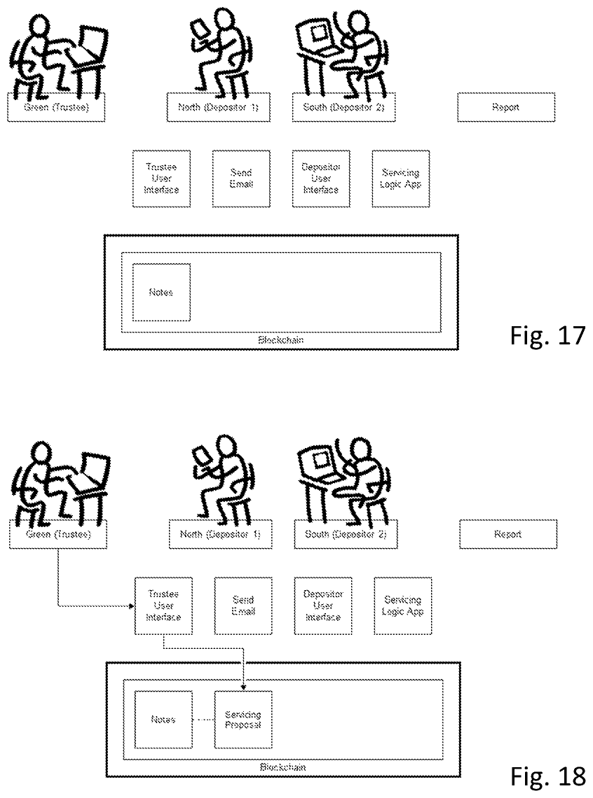

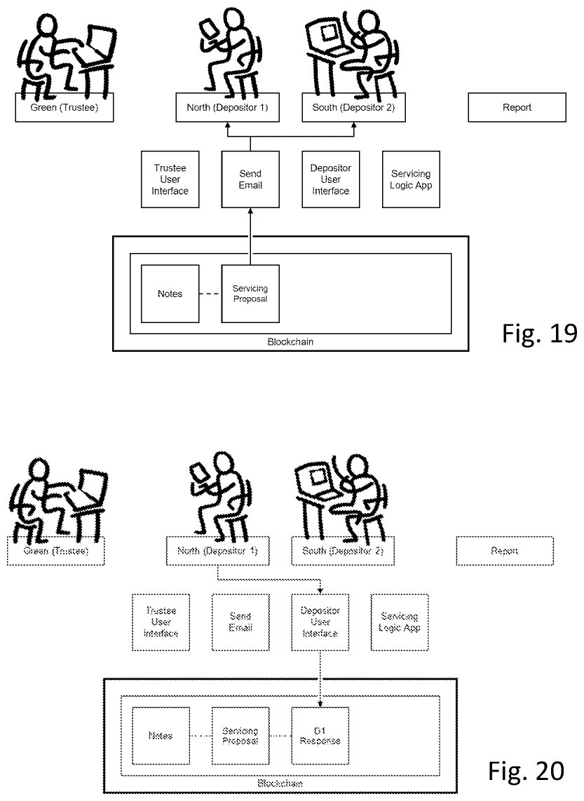

In order to propose a change in servicer, Green will access the trustee user interface, as shown in FIG. 18, and this proposal will be written to the blockchain. In FIG. 19, an application watches for such additions to the blockchain and determines the identities of the affected depositors (North and South) by querying the blockchain or offchain database, and notifies these depositors by E-mail. The notification message will generally describe the proposal and may include a link for the depositors to access the voting panel. The notification generation application may use an automated template to generate the notification message and customize the message with data retrieved from the blockchain or an offchain database. The system then waits for the respective depositors to respond to the proposal for the change in servicer, for example, using the interface shown in FIG. 8. Querying the offchain database is less computationally intensive than querying the blockchain and allows for faster searches and report generation.

In FIG. 20, North (Depositor 1) is shown accessing the depositor user interface to record an acknowledgement of the change of servicer. The acknowledgement is recorded in the blockchain as a “Yes” vote. In contrast to North, South (Depositor 2) does not submit any response to the proposal from Green, as shown in FIG. 21.

Under conventional practices, the asset-backed securitization documents are prepared such that any proposed change in servicer must receive an affirmative response or acknowledgement from all relevant parties. In contrast, the present invention has logic such that if any party does not respond to the proposal within a predetermined amount of time, the system considers that non-response as an acceptance of the trustee's proposal and the servicer replacement will take place, unless there is an affirmative “No” vote. Such practices can be agreed to by the transaction parties or by the securitization industry participants as part of adoption of the blockchain platform.

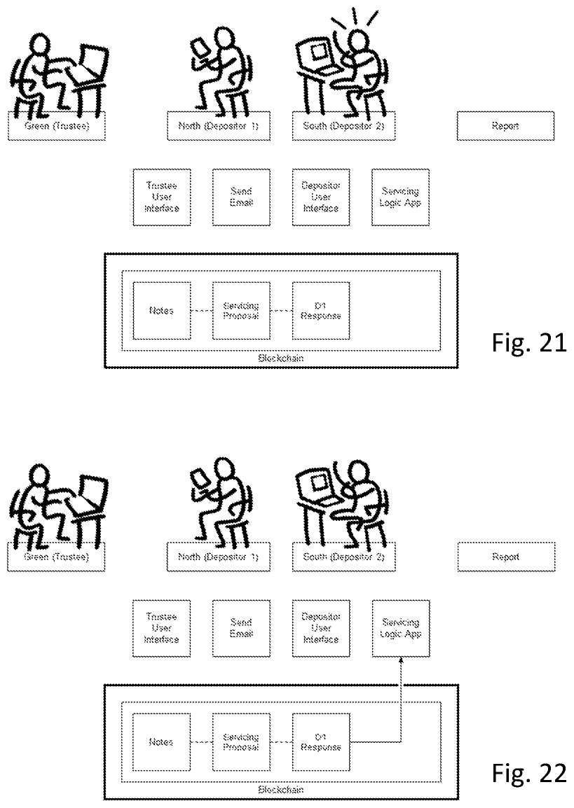

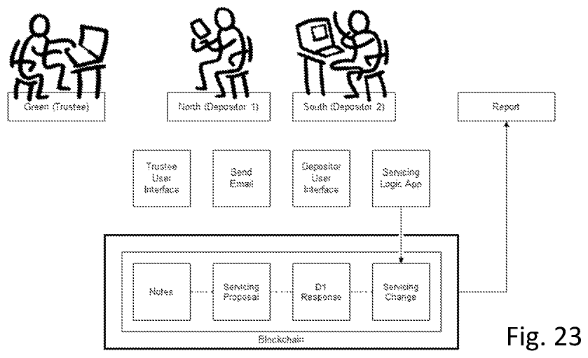

In FIG. 22, the servicer replacement application reviews the recorded responses in the blockchain to the proposal to change servicer, at or near to the effective date of the proposal, and takes appropriate action. The servicer replacement application will write the change in servicer as a transaction in the blockchain and the changed servicer will show in the report that is generated with the result of the voting (FIG. 23).

Certain embodiments of the invention may have error-checking rules to reduce opportunities for incorrect data entry. For example, if a user enters “Wheels Fargo” for the name of a party, and the system does not locate the typed name, the system may issue a prompt asking the user for verification of the name or whether an alternative name was intended, such as “Did you mean ‘Wells Fargo Bank, N.A.’?”. Similarly, if a user enters a numerical value for a quantity, such as “10000”, the system may ask “Did you mean $10,000 or $100.00?”. In certain embodiments, the system may provide drop-down lists of entries so that a user may select a name from the list and thereby avoid mistyping data. Other types of error-checking rules can be adopted in accordance with particular implementations of the invention.

The final product of the invention can take a number of forms. In an exemplary embodiment, the final product of the invention is a general ledger containing the newly-added or updated information regarding split loans included in all CM BS securitizations and the owners of each of the related split notes and, if a split note has been included in a securitization, each of the transaction parties in such securitization. In another exemplary embodiment, the final product of the invention is a report showing newly-added or newly-updated information, such as new split loans or an identification of new parties such as owner, administrator, trustee, depositor, etc. The report can be generated automatically from the blockchain, or a counterpart offchain database, as a final step of the inventive method, or the report can be generated upon receipt of an instruction or a query, for example, from an administrator.

In certain embodiments, the data written to the blockchain may also be written to an offchain database which replicates the information in the blockchain and maintains the offchain database and blockchain in synchrony. The offchain database can be searched using standard queries such as (but not limited to) SQL. As discussed above, searching the offchain database using SQL (or another query language) is less computationally intense than searching the blockchain, as the data in the blockchain is encrypted and therefore must be decrypted to be read.

Examples of changes, substitutions, and alterations are ascertainable by one skilled in the art and could be made without departing from the scope of the invention disclosed herein. All references cited herein are incorporated by reference in their entirety and made part of this application.

The various embodiments described above can be combined to provide further embodiments. Aspects of the embodiments can be modified to provide yet further embodiments. The disclosed features may be implemented, in any combination and subcombination (including multiple dependent combinations and subcombinations), with one or more other features described herein. The various features described or illustrated above, including any components thereof, may be combined or integrated in other systems. In addition, the embodiments described in the dependent claims can be combined with other independent claims to provide still further embodiments, even if not expressly recited or described. Moreover, certain features may be omitted or not implemented. For example, when the invention is discussed with reference to the data crawler parsing data from a custom blockchain exhibit, the invention can be equally performed by the data crawler parsing data from the transaction reporting documents.

Other objects, advantages and embodiments of the various aspects of the present invention will be apparent to those who are skilled in the field of the invention and are within the scope of the description and the accompanying figures. For example, but without limitation, structural or functional elements might be rearranged, or method steps reordered, consistent with the present invention. Similarly, an element may comprise a single instance of an element or comprise a plurality of elements, such plurality functioning as a single unitary component. The structure of the invention described in various embodiments is not meant to limit the invention to those embodiments or aspects of the present invention, and other components that may accomplish similar tasks may be implemented as well. Similarly, principles according to the present invention, and methods and systems that embody them, could be applied to other examples, which, even if not specifically described here in detail, would nevertheless be within the scope of the present invention.

1. A computer-based method comprising:
(a) identifying, from a set of transaction reporting documents for an asset-backed securitization backed by a pool of underlying financial assets, a collection of transaction reporting documents having a custom blockchain exhibit;
(b) parsing each identified blockchain exhibit of the collection to extract data which is to be added to a blockchain and generating a crawler object from the extracted data, each crawler object representing data parsed from a single blockchain exhibit from the collection, and a plurality of crawler objects forming a crawler object library;
(c) parsing the crawler object library and generating a data object library, each unique data object representing a single transaction to be added to the blockchain and having an associated instruction to add each unique transaction to the blockchain;
(d) executing the instructions in the data object library to add each transaction and the data associated thereto to the blockchain; and
(e) generating a report showing the updates to the blockchain.

2. The method according to claim 1, wherein the set of transaction reporting documents is a repository managed by a regulatory agency, an industry group, a public entity, or a private entity.

3. The method according to claim 1, wherein the step of identifying the transaction reporting document having the blockchain exhibit comprises crawling an index file of the set of transaction reporting documents to identify transaction reporting documents satisfying one or more criteria.

4. The method according to claim 3, wherein the criteria are selected from one or more of document type and standard industry classification (SIC) code.

5-13. (canceled)

14. The method according to claim 1, wherein the method is carried on a distributed ledger platform and further comprises the step of replicating the blockchain in each node of the distributed ledger platform.

15. The method according to claim 1, further comprising managing an offchain database in synchrony with the blockchain.

16. The method according to claim 1, wherein the step of managing the blockchain and the offchain database in synchrony comprises the steps of
(a) identifying one or more transaction records of the financial asset in the offchain database;
(b) identifying one or more transaction records of the financial asset in the blockchain;
(c) comparing the identified transaction records of the offchain database and the blockchain;
(d) identifying transaction records to be superseded in the offchain database, the blockchain, or both; and.
(e) writing to the blockchain and/or the offchain database a superseding transaction record reconciling discrepant financial asset data.

17. A computer-based method comprising:
(a) identifying, from a set of transaction reporting documents for an asset-backed securitization backed by a pool of underlying financial assets, a collection of transaction reporting documents;
(b) parsing each transaction reporting document of the collection to extract data which is to be added to a blockchain and generating a crawler object from the extracted data, each crawler object representing data parsed from the collection, and a plurality of crawler objects forming a crawler object library;
(c) parsing the crawler object library and generating a data object library, each unique data object representing a single transaction to be added to the blockchain and having an associated instruction to add each unique transaction to the blockchain;
(d) executing the instructions in the data object library to add each transaction and the data associated thereto to the blockchain; and
(e) generating a report showing the updates to the blockchain.

18-32. (canceled)

33. A method, comprising:
(a) searching, via a node of a distributed ledger platform, a set of transaction reporting documents for an asset-backed securitization backed by a pool of underlying financial assets for a transaction reporting document comprising associated financial asset data;
(b) extracting from the transaction reporting document, via the node, associated financial asset data therein;
(c) building, via the node, an instruction to compare the extracted financial asset data to a blockchain database comprising data for a plurality of financial assets;
(d) assessing, via the node, based on the comparison whether the financial asset is a securitized asset or a non-securitized asset;
(e) communicating the assessed securitization status of the financial asset to the blockchain;
(f) writing, via the node, the securitization status of the financial asset to the blockchain; and
(g) reconciling, via the node, the securitization status of the financial asset in the blockchain with the securitization status of the financial asset in an offchain database.

34. A method comprising the steps of:
(a) permitting an administrator to select an asset-backed securitization serviced by a current servicer;
(b) preparing an electronic proposal to replace the current servicer with a replacement servicer, the proposal having a specified termination date, wherein the proposal automatically retrieves the identity of an approver associated with the impacted financial assets from an offchain database for the proposal;
(c) soliciting a response to the proposal from the approver; and;
(d) utilizing a smart contract algorithm to tabulate the responses and act upon the results; and
(e) based upon the results of such tabulation, if necessary, entering the change of servicer to the replacement servicer as a transaction in a blockchain file upon failure to receive an objection from the approver by the termination date or affirmative approval by the approver.

35-41. (canceled)

42. An apparatus, comprising: at least one processor; and a memory storing executable instructions that, when executed by the at least one processor, causes the at least one processor to perform the steps of:
(a) identifying, from a set of transaction reporting documents for an asset-backed securitization, a collection of reporting documents;
(b) parsing each identified transaction reporting document of the collection to extract data which is to be added to a blockchain and generating a crawler object from the extracted data, each crawler object representing data parsed from the collection, and a plurality of crawler objects forming a crawler object library;
(c) parsing the crawler object library and generating a data object library, each data object representing a single transaction to be added to the blockchain and having an associated instruction to add the transaction to the blockchain;
(d) executing the instructions in the data object library to add each transaction and the data associated thereto to the blockchain; and
(e) generating a report showing the updates to the blockchain.

43. A computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising:
(a) identifying, from a set of transaction reporting documents for a financial asset, a collection of reporting documents;
(b) parsing each identified transaction reporting document of the collection to extract data which is to be added to a blockchain and generating a crawler object from the extracted data, each crawler object representing data parsed from the collection, and a plurality of crawler objects forming a crawler object library;
(c) parsing the crawler object library and generating a data object library, each data object representing a single transaction to be added to the blockchain and having an associated instruction to add the transaction to the blockchain;
(d) executing the instructions in the data object library to add each transaction and the data associated thereto to the blockchain; and
(e) generating a report showing the updates to the blockchain.

44. A system, comprising: a processor; and a computer-readable storage medium having instructions stored which, when executed by the processor, cause the processor to perform operations comprising:
(a) identifying, from a set of transaction reporting documents for an asset-backed securitization, a collection of reporting documents;
(b) parsing each identified transaction reporting document of the collection to extract data which is to be added to a blockchain and generating a crawler object from the extracted data, each crawler object representing data parsed from the collection, and a plurality of crawler objects forming a crawler object library;
(c) parsing the crawler object library and generating a data object library, each data object representing a single transaction to be added to the blockchain and having an associated instruction to add the transaction to the blockchain;
(d) executing the instructions in the data object library to add each transaction and the data associated thereto to the blockchain; and
(e) generating a report showing the updates to the blockchain.

45. A non-transitory computer-readable storage medium having instructions stored which, when executed by a computing device, cause the computing device to perform operations comprising:
(a) identifying, from a set of transaction reporting documents for an asset-backed securitization, a collection of reporting documents;
(b) parsing each identified transaction reporting document of the collection to extract data which is to be added to a blockchain and generating a crawler object from the extracted data, each crawler object representing data parsed from the collection, and a plurality of crawler objects forming a crawler object library;
(c) parsing the crawler object library and generating a data object library, each data object representing a single transaction to be added to the blockchain and having an associated instruction to add the transaction to the blockchain;
(d) executing the instructions in the data object library to add each transaction and the data associated thereto to the blockchain; and
(e) generating a report showing the updates to the blockchain.

46. A node of a blockchain system, the node comprising a processor configured to perform the steps of:
(a) identifying, from a set of transaction reporting documents for an asset-backed securitization, a collection of reporting documents;
(b) parsing each identified transaction reporting document of the collection to extract data which is to be added to a blockchain and generating a crawler object from the extracted data, each crawler object representing data parsed from the collection, and a plurality of crawler objects forming a crawler object library;
(c) parsing the crawler object library and generating a data object library, each data object representing a single transaction to be added to the blockchain and having an associated instruction to add the transaction to the blockchain;
(d) executing the instructions in the data object library to add each transaction and the data associated thereto to the blockchain; and
(e) generating a report showing the updates to the blockchain.

47. A computer-based method comprising:
(a) identifying, from a set of transaction reporting documents for an asset-backed securitization, a collection of transaction reporting documents having a custom blockchain exhibit;
(b) parsing each identified blockchain exhibit of the collection to extract data which is to be added to a blockchain and generating a crawler object from the extracted data, each crawler object representing data parsed from a single blockchain exhibit from the collection, and a plurality of crawler objects forming a crawler object library;
(c) parsing the crawler object library and generating a data object library, each data object representing a single transaction to be added to the blockchain and having an associated instruction to add the transaction to the blockchain;
(d) executing the instructions in the data object library to add each transaction and the data associated thereto to the blockchain; and
(e) generating a report showing the updates to the blockchain.

48. A system for managing data using distributed ledger technology, the system comprising: a first entity node comprising:
a processor;
a communication interface; and
a memory having a blockchain application stored therein, wherein the blockchain application comprises a blockchain comprising a plurality of data records, wherein the blockchain application, when executed by the processor, causes the processor to:
(a) crawl a set of transaction reporting documents to identify one or more custom blockchain exhibits;
(b) parse each custom blockchain exhibit and generate a pending data object for each blockchain exhibit to be added to the blockchain;
(c) generate a pending transaction object representing a single transaction to be added to the blockchain and an associated instruction to add the transaction to the blockchain;
(d) convert each pending data object and pending transaction object to a permanent data record by appending the pending data record to the blockchain; and.
(e) generate a report showing the updates to the blockchain.

49. A data management system using distributed ledger technology, the system comprising a plurality of nodes, wherein at least one of the plurality of nodes is a computing system configured to broadcast securities data to the plurality of nodes; and wherein each of the plurality of nodes comprises a processor, a memory unit, and a bus, wherein each of the plurality of nodes is connected to each other over a communication network, wherein each of the plurality of nodes has access to a copy of a distributed ledger, wherein the processor of each of the plurality of nodes is configured to:
(a) utilize blockchain protocols to verify and record a transaction occurring within the distributed ledger, wherein data is recorded as a block, wherein a blockchain is formed by the addition of blocks, wherein each block is encrypted by a mathematical formula that produces a hash value, wherein each block is linked to a previous block by the hash value of the previous block, wherein a consensus must be reached to update the distributed ledger with the addition of a new block;
(b) crawl a set of transaction reporting documents to identify one or more custom blockchain exhibits;
(c) parse each custom blockchain exhibit and generate a pending data object for each blockchain exhibit to be added to the blockchain;
(d) generate a pending transaction object representing a transaction to be added to the blockchain and an associated instruction to add the transaction to the blockchain;
(e) convert each pending data object and pending transaction object to a permanent data record by appending the pending data record to the blockchain; and
(f) generate a report showing the updates to the blockchain.

50. A computer-based method comprising:
(a) accessing, by a processor, a financial assets management database shared by all computing nodes participating in a distributed computing system based on a blockchain protocol, the financial assets management database including transaction data and financial assets data, where the transaction data comprise transaction records relating to financial assets and the financial assets data comprise administrative records relating to financial assets, the blockchain comprising record blocks that confirm when and in what sequence certain transaction data became written to the blockchain;
(b) receiving a request signed by a user system to include new data in the blockchain, where the new data has been previously parsed from a custom blockchain exhibit in a document repository, and the new data comprises new transaction objects and/or new data objects representing a change in transaction data and/or financial assets data of a financial asset and an instruction to add the new data to the blockchain;
(c) executing the instruction to thereby add a block that records the new transaction with additional data in the blockchain including a hash of a previous block and the block which is being added; and
(d) generating a report showing the updates to the blockchain.

51. A method comprising the steps of:
(a) identifying transaction reporting documents in a repository filed by an issuing entity within a pre-defined reporting period, and saving data comprising document type and filing date in a blockchain of a distributed ledger;
(b) determining a filing due date within the reporting period for each of the transaction reporting documents in the blockchain;
(c) comparing respective filing due date and filing date for each of the transaction reporting documents within the reporting period; and
(d) generating a report showing the results of the comparison.
